(19) United States
(12) Patent Application Publication
(10) Pub. No.: US 2014/0063831 A1
(43) Pub. Date: Mar. 6, 2014

(54) METHODS OF MAKING AND ARTICLES COMPRISING A YELLOWING RESISTANT POLYCARBONATE COMPOSITION

(71) Applicant: SABIC Innovative Plastics IP B.V., Bergen op Zoom (NL)

(72) Inventors: Daniel Lowery, Mount Vernon, IN (US); Peter Vollenberg, Eindhoven (NL); James Mahood, Evansville, IN (US)

(73) Assignee: SABIC Innovative Plastics IP B.V., Bergen op Zoom (NL)

(21) Appl. No.: 13/968,987

(22) Filed: Aug. 16, 2013

Related U.S. Application Data
(60) Provisional application No. 61/695,897, filed on Aug. 31, 2012.

(51) Int. Cl. F21S 8/10

(52) U.S. Cl. CPC F21S 48/1394
USPC 362/516; 525/462; 524/537; 524/106; 524/141; 524/291; 521/134; 528/196

(57) ABSTRACT

Disclosed herein are methods and compositions of polycarbonate blends having, among other characteristics, improved heat resistance. The resulting polycarbonate blends, comprising a first polycarbonate comprising structural repeating units derived from bisphenol acetophenone and optionally a second polycarbonate polymer comprising structural repeating units derived from bisphenol A, can be used in the manufacture of articles while still retaining the advantageous physical properties of blended polycarbonate compositions with improved heat resistance. The disclosed polycarbonate blends optionally comprise one or more polycarbonate blend additives. This abstract is intended as a scanning tool for purposes of searching in the particular art and is not intended to be limiting of the present invention.

### CROSS-REFERENCE TO RELATED APPLICATIONS

This application claims the benefit of U.S. Provisional Application No. 61/695,897, filed on Aug. 31, 2012, which is incorporated herein by reference in its entirety.

### BACKGROUND OF THE INVENTION

The present invention relates to articles formed from polycarbonate blends having, among other characteristics, improved heat resistance, and specifically to articles formed from polycarbonate blends having increased heat deflection temperature, decreased initial yellowness index, increased stability of yellowness index to weathering, and improved clarity. Also included herein are polycarbonate blends, methods for preparing and/or using the same, as well as articles formed from such polycarbonate blends.

Polycarbonates (PC) are synthetic thermoplastic resins that can be derived from bisphenols and phosgenes, or their derivatives by an interfacial polymerization, or from bisphenols and a diaryl carbonate by a melt polymerization process. Polycarbonates are a useful class of polymers having many desired properties. They are highly regarded for optical clarity and enhanced impact strength and ductility at room temperature.

Various articles, including lens used with various light sources, transparent face shields, electronic displays, and the like, increasingly utilize plastic materials for design and economic reasons. Many of these uses are in environments that utilize a light source that results in significant heat generation and build-up of heat. The article must necessarily be stable to exposure to high and sustained heat, and importantly, desirable properties such as transparency, minimal color, and freedom from distortion must be stable under such conditions.

Automotive headlamps are increasingly utilizing light sources which operate at higher temperatures and generate greater heat loads than in the past. Headlamps are increasingly becoming a more integral part of the automobile design to improve the aerodynamics of the automobile design and to improve the aesthetic appearance of the automobile. The result is the interior volume enclosed by the headlamp assembly comprising a housing, a reflector, a bezel, and a lens, is decreasing due to changes in design aesthetics, e.g. headlamps that are a more integral part of the automobile design. The result is that critical components such as the lens are closer to the light (and heat) source, and thus requiring using of materials that have an increased heat resistance while retaining other necessary material characteristics such as optical clarity and color stability.

The material used for manufacture of contemporary headlamp lens has been bisphenol A (“BPA”) based polycarbonate or a high heat polycarbonate. However, these materials fall short of addressing the current requirements for headlamp lens. For example, BPA-based polycarbonates do not have the requisite heat resistance, although these polycarbonates do have the desired optical clarity and color stability. Although currently used high heat polycarbonates possess the desired heat resistance characteristics there is a desire for better color stability and/or have the desired optical clarity.

There remains a need in the art for polycarbonate compositions, and articles formed from such compositions, having improved heat resistance, while maintaining desirable properties at elevated temperatures such as transparency and minimal distortion.

### SUMMARY OF THE INVENTION

In accordance with the purpose(s) of the present invention, as embodied and broadly described herein, this disclosure, in one aspect, relates to articles formed from polycarbonate blends having, among other characteristics, improved heat resistance. In various aspects, the articles are formed from polycarbonate blends having increased heat deflection temperature, decreased initial yellowness index, and increased stability of yellowness index to weathering. The articles are formed from polycarbonate blends comprising a first polycarbonate comprising structural repeating units derived from bisphenol acetophenone and optionally a second polycarbonate polymer comprising structural repeating units derived from bisphenol A. In various aspects, the disclosed polycarbonate blends optionally comprise one or more polycarbonate blend additives selected from thermal stabilizers, antioxidants, UV stabilizers, plasticizers, visual effect enhancers, extenders, antistatic agents, catalyst quenchers, mold releasing agents, fire retardants, blowing agents, impact modifiers and processing aids.

In one aspect, the invention relates to an article comprising a polycarbonate blend, the polycarbonate blend comprising:
(a) from about 10 wt % to about 100 wt % of a first polycarbonate comprising about 10 mol % to about 100 mol % structural units derived from bisphenol acetophenone and about 0 mol % to about 90 mol % structural units derived from bisphenol A; and
(b) from about 0 wt % to about 90 wt % of a second polycarbonate comprising structural units derived from bisphenol A;
   wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75. In a further aspect, the first polycarbonate is a homopolymer comprising structural units derived from bisphenol acetophenone. In a still further aspect, the second polycarbonate is present in about 0 wt %.

In a further aspect, the polycarbonate blend exhibits a transmission measurement of the polycarbonate blend is greater than or equal to about 85% when measured in accordance with ASTM D-1003; and a falling dart impact strength of the polycarbonate blend is greater than or equal to about 70 J when tested in accordance with ASTM D-3029 on molded plaques of 3.2 mm thickness.

In a further aspect, the first polycarbonate has a Mw of between about 20,000 Daltons and about 35,000 Daltons. In an even further aspect, the first polycarbonate has a Mw of between about 20,000 Daltons and about 30,000 Daltons. In a yet further aspect, the first polycarbonate has a Mn of between about 10,000 Daltons and about 20,000 Daltons. In an still further aspect, the first polycarbonate has a Mw of between about 20,000 Daltons and about 30,000 Daltons; and a Mn of between about 10,000 and about 20,000.

In a further aspect, the second polycarbonate has a Mw of between about 21,000 Daltons and about 31,000 Daltons. In a yet further aspect, the first polycarbonate has a Mn of between about 10,500 Daltons and about 15,500 Daltons. In a still further aspect, the first polycarbonate has a Mw of between about 21,000 Daltons and about 31,000 Daltons; and a Mn of between about 10,500 Daltons and about 15,500 Daltons.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 shows representative yellowness index (“YI”) data for two representative disclosed polycarbonate blends of the present invention compared to representative comparator samples.

FIG. 2 shows representative delta yellowness index (“dYI”) data for two representative disclosed polycarbonate blends of the present invention compared to representative comparator samples.

FIG. 3 shows representative extinction coefficient data (250-375 nm) for a representative disclosed polycarbonate blend of the present invention compared to a representative comparator sample.

FIG. 4 shows a representative headlamp assembly from the perspective of the right front quadrant of a motor vehicle.

FIG. 5 shows a cross-section of the representative headlamp shown in FIG. 4.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE INVENTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a ketone” includes mixtures of two or more ketones.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question may be the value designated, some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example if a particular element or component in a composition or article is said to have 8% weight, it is understood that this percentage is relation to a total compositional percentage of 100%.

The term “alkyl group” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “alkoxy” as used herein is an alkyl group bound through a single, terminal ether linkage; that is, an “alkoxy” group can be defined as —OR where R is alkyl as defined above. A “lower alkoxy” group is an alkoxy group containing from one to six carbon atoms.

The term “alkenyl group” as used herein is a hydrocarbon group of from 2 to 24 carbon atoms and structural formula containing at least one carbon-carbon double bond. Asymmetric structures such as (AB)C=C(CD) are intended to include both the E and Z isomers. This can be presumed in structural formulae herein wherein an asymmetric alkene is present, or it can be explicitly indicated by the bond symbol C.

The term “alkynyl group” as used herein is a hydrocarbon group of 2 to 24 carbon atoms and a structural formula containing at least one carbon-carbon triple bond.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “cycloalkyl group” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl group” is a cycloalkyl group as defined above where at least one of the carbon atoms of the ring is substituted with a heteroatom such as, but not limited to, nitrogen, oxygen, sulphur, or phosphorus.

The term “aralkyl” as used herein is an aryl group having an alkyl, alkynyl, or alkenyl group as defined above attached to the aromatic group. An example of an aralkyl group is a benzyl group.

The term “hydroxyalkyl group” as used herein is an alkyl, alkenyl, alkynyl, aryl, aralkyl, cycloalkyl, halogenated alkyl, or heterocycloalkyl group described above that has at least one hydrogen atom substituted with a hydroxyl group.

The term “alkoxyalkyl group” is defined as an alkyl, alkenyl, alkynyl, aryl, aralkyl, cycloalkyl, halogenated alkyl, or heterocycloalkyl group described above that has at least one hydrogen atom substituted with an alkoxy group described above.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “carbonate group” as used herein is represented by the formula —OC(O)OR, where R can be hydrogen, an alkyl, alkenyl, alkynyl, aryl, aralkyl, cycloalkyl, halogenated alkyl, or heterocycloalkyl group described above.

The term “carboxylic acid” as used herein is represented by the formula —C(O)OH.

The term “aldehyde” as used herein is represented by the formula —C(O)H.

The term “keto group” as used herein is represented by the formula —C(O)R, where R is an alkyl, alkenyl, alkynyl, aryl, aralkyl, cycloalkyl, halogenated alkyl, or heterocycloalkyl group described above.

The term “carbonyl group” as used herein is represented by the formula C═O.

The term “ether” as used herein is represented by the formula AOA¹, where A and A¹ can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “sulfo-oxo group” as used herein is represented by the formulas —S(O)₂R, —OS(O)₂R, or, —OS(O)₂OR, where R can be hydrogen, an alkyl, alkenyl, alkynyl, aryl, aralkyl, cycloalkyl, halogenated alkyl, or heterocycloalkyl group described above.

The terms “BisAP,” “bisphenol AP,” or “bisphenol acetophenone,” which can be used interchangeably, as used herein refers to a compound having a structure represented by the formula:

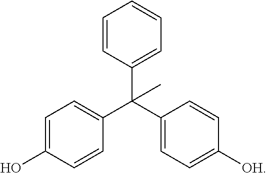 [SMILES: CC(c1ccccc1)(c1ccc(O)cc1)c1ccc(O)cc1]

BisAP can also be referred to by the name 4,4′-(1-phenylethylidene)bisphenol; 1,1-bis(4-hydroxyphenyl)-1-phenylethane; or 1,1-bis(4-hydroxyphenyl)methylphenylmethane. BisAP has the CAS #1571-75-1.

The terms “BisAP-PC” or “bisphenol AP-PC,” which can be used interchangeably, as used herein refers to a polycarbonate copolymer comprising repeating carbonate units derived from BisAP and at least one other dihydroxy monomer such as a bisphenol. For example, BisAP-PC can be a polycarbonate copolymer comprising BisAP and bisphenol A monomer units.

As used herein, the terms “number average molecular weight” or “Mn” can be used interchangeably, and refer to the statistical average molecular weight of all the polymer chains in the sample and is defined by the formula:

$$Mn = \frac{\sum {N}_{i} {M}_{i}}{\sum {N}_{i}} ,$$

where Mᵢ is the molecular weight of a chain and Nᵢ is the number of chains of that molecular weight. Mn can be determined for polymers, such as polycarbonate polymers or polycarbonate-PMMA copolymers, by methods well known to a person having ordinary skill in the art. It is to be understood that as used herein, Mn is measured gel permeation chromatography and as calibrated with polycarbonate standards. For example, gel permeation chromatography can be carried out using a crosslinked styrene-divinyl benzene column, at a sample concentration of 1 milligram per milliliter with appropriate mobile phase solvents.

As used herein, the terms “weight average molecular weight” or “Mw” can be used interchangeably, and are defined by the formula:

$$Mw = \frac{\sum {N}_{i} {M}_{i}^{2}}{\sum {N}_{i} {M}_{i}} ,$$

where M₁ is the molecular weight of a chain and N₁ is the number of chains of that molecular weight. Compared to Mn, Mw takes into account the molecular weight of a given chain in determining contributions to the molecular weight average. Thus, the greater the molecular weight of a given chain, the more the chain contributes to the Mw. It is to be understood that as used herein, Mw is measured gel permeation chromatography and as calibrated with polycarbonate standards. For example, gel permeation chromatography can be carried out using a crosslinked styrene-divinyl benzene column, at a sample concentration of 1 milligram per milliliter with appropriate mobile phase solvents.

As used herein, the terms “polydispersity index” or “PDI” can be used interchangeably, and are defined by the formula:

PDI=Mw/Mn.

The PDI has a value equal to or greater than 1, but as the polymer chains approach uniform chain length, the PDI approaches unity.

The terms “polycarbonate” or “polycarbonates” as used herein includes copolycarbonates, homopolycarbonates and (co)polyester carbonates.

The terms “residues” and “structural units”, used in reference to the constituents of the polymers, are synonymous throughout the specification.

The term “transparent” is defined herein as an absence of cloudiness, haziness, and muddiness when inspected visually. Transparency was determined by measuring transmission, haze, and yellowness index (YI) using a Gardner Colorimeter.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Polycarbonate Blends

As briefly described above, the present invention, provides in one aspect, articles formed from polycarbonate blends having, among other characteristics, improved heat resistance. In various aspects, the articles are formed from polycarbonate blends having increased heat deflection temperature, decreased initial yellowness index, increased stability of yellowness index to weathering, and improved clarity. The articles are formed from polycarbonate blends comprising a first polycarbonate comprising structural repeating units derived from bisphenol acetophenone and optionally a second polycarbonate polymer comprising structural repeating units derived from bisphenol A. In various aspects, the disclosed polycarbonate blends optionally comprise one or more polycarbonate blend additives selected from thermal stabilizers, antioxidants, UV stabilizers, plasticizers, visual effect enhancers, extenders, antistatic agents, catalyst quenchers, mold releasing agents, fire retardants, blowing agents, impact modifiers and processing aids.

In various aspects, the invention relates to polycarbonate blends, the polycarbonate blend comprising: from about 10 wt % to about 100 wt % of a first polycarbonate comprising about 10 mol % to about 100 mol % structural units derived from bisphenol acetophenone and about 0 mol % to about 90 mol % structural units derived from bisphenol A; and from about 0 wt % to about 90 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In a further aspect, the first polycarbonate comprises about 0 mol % structural units derived from bisphenol A and about 100 mol % structural units derived from bisphenol acetophenone. In a still further aspect, the first polycarbonate comprises from about 0 mol % to about 20 mol % structural units derived from bisphenol A and about 80 mol % to about 100 mol % structural units derived from bisphenol acetophenone. In a yet further aspect, the first polycarbonate comprises from about 0 mol % to about 10 mol % structural units derived from bisphenol A and comprises about 90 mol % to about 100 mol % structural units derived from bisphenol acetophenone. In an even further aspect, the first polycarbonate comprises from about 0 mol % to about 5 mol % structural units derived from bisphenol A and comprises about 95 mol % to about 100 mol % structural units derived from bisphenol acetophenone.

In a further aspect, the first polycarbonate is present in about 90 wt % and the second polycarbonate is present in about 10 wt %. In a still further aspect, the polycarbonate blend comprises a first polycarbonate present in about 100 wt %.

In a further aspect, the first polycarbonate has a Mw of between about 20,000 Daltons and about 30,000 Daltons. In a still further aspect, the first polycarbonate has a Mn of between about 10,000 Daltons and about 20,000 Daltons. In a yet further aspect, the first polycarbonate has a Mw of between about 20,000 Daltons and about 30,000 Daltons; and wherein the first polycarbonate has a Mn of between about 10,000 Daltons and about 20,000 Daltons. In a further aspect, the first polycarbonate has a melt flow rate (“MFR”) from about 10 g per 10 minutes to about 20 g per 10 minutes at 330° C. under a load of 2.16 kg when measured according to ISO 1133.

In a further aspect, the second polycarbonate has a Mw of between about 21,000 Daltons and about 31,000 Daltons. In a still further aspect, the second polycarbonate has a Mn of between about 10,500 Daltons and about 15,500 Daltons. In a yet further aspect, the second polycarbonate has a Mw of between about 21,000 Daltons and about 31,000 Daltons; and wherein the second polycarbonate has a Mn of between about 10,500 Daltons and about 15,500 Daltons. In a further aspect, the second polycarbonate has a melt flow rate (“MFR”) from about 5 g per 10 minutes to about 20 g per 10 minutes at 330° C. under a load of 2.16 kg when measured according to ISO 1133.

In a further aspect, the yellowness index of the polycarbonate blend has an initial value of less than or equal to about 2.5 when tested on molded plaques of 3.2 mm thickness in accordance with ASTM E313. In a still further aspect, the yellowness index of the polycarbonate blend has an initial value of less than or equal to about 2.0 when tested on molded plaques of 3.2 mm thickness in accordance with ASTM E313. In a yet further aspect, the yellowness index of the polycarbonate blend has an initial value of less than or equal to about 1.5 when tested on molded plaques of 3.2 mm thickness in accordance with ASTM E313. In an even further aspect, the yellowness index of the polycarbonate blend has an initial value of less than or equal to about 1.3 when tested on molded plaques of 3.2 mm thickness in accordance with ASTM E313. In a still further aspect, the yellowness index of the polycarbonate blend has an initial value of less than or equal to about 1.1 when tested on molded plaques of 3.2 mm thickness in accordance with ASTM E313. In a yet further aspect, the yellowness index of the polycarbonate blend has an initial value of less than or equal to about 1.0 when tested on molded plaques of 3.2 mm thickness in accordance with ASTM E313.

In a further aspect, the delta yellowness index of the polycarbonate blend is less than or equal to about 5.0 after heat aging in air at about 140° C. for about 20 days when tested on molded plaques of 3.2 mm thickness in accordance with ASTM E313. In a still further aspect, the delta yellowness index of the polycarbonate blend is less than or equal to about 4.0 after heat aging in air at about 140° C. for about 20 days when tested on molded plaques of 3.2 mm thickness in accordance with ASTM E313. In a yet further aspect, the delta yellowness index of the polycarbonate blend is less than or equal to about 3.0 after heat aging in air at about 140° C. for about 20 days when tested on molded plaques of 3.2 mm thickness in accordance with ASTM E313. In an even further aspect, the delta yellowness index of the polycarbonate blend is less than or equal to about 2.5 after heat aging in air at about 140° C. for about 20 days when tested on molded plaques of 3.2 mm thickness in accordance with ASTM E313. In a still further aspect, the delta yellowness index of the polycarbonate blend is less than or equal to about 2.0 after heat aging in air at about 140° C. for about 20 days when tested on molded plaques of 3.2 mm thickness in accordance with ASTM E313. In a yet further aspect, the delta yellowness index of the polycarbonate blend is less than or equal to about 7.0 after heat aging in air at about 140° C. for about 40 days when tested on molded plaques of 3.2 mm thickness in accordance with ASTM E313. In an even further aspect, the delta yellowness index of the polycarbonate blend is less than or equal to about 6.5 after heat aging in air at about 140° C. for about 40 days when tested on molded plaques of 3.2 mm thickness in accordance with ASTM E313. In a still further aspect, the delta yellowness index of the polycarbonate blend is less than or equal to about 6.0 after heat aging in air at about 140° C. for about 40 days when tested on molded plaques of 3.2 mm thickness in accordance with ASTM E313. In a yet further aspect, the delta yellowness index of the polycarbonate blend is less than or equal to about 5.5 after heat aging in air at about 140° C. for about 40 days when tested on molded plaques of 3.2 mm thickness in accordance with ASTM E313. In an even further aspect, the delta yellowness index of the polycarbonate blend is less than or equal to about 5.0 after heat aging in air at about 140° C. for about 40 days when tested on molded plaques of 3.2 mm thickness in accordance with ASTM E313.

In a further aspect, the polycarbonate blend has less than or equal to about a 6.0% decrease in Mw after exposure to 90° C. and 100% relative humidity for seven days. In a still further aspect, the polycarbonate blend has less than or equal to about a 5.0% decrease in Mw after exposure to 90° C. and 100% relative humidity for seven days. In a yet further aspect, the polycarbonate blend has less than or equal to about a 4.0% decrease in Mw after exposure to 90° C. and 100% relative humidity for seven days.

In a further aspect, the polycarbonate blend has a haze measurement of less than or equal to about 7.0% when measured in accordance with ASTM D-1003. In a still further aspect, the polycarbonate blend has a haze measurement of less than or equal to about 6.0% when measured in accordance with ASTM D-1003. In a yet further aspect, the polycarbonate blend has a haze measurement of less than or equal to about 5.0% when measured in accordance with ASTM D-1003. In an even further aspect, the polycarbonate blend has a haze measurement of less than or equal to about 4.0% when measured in accordance with ASTM D-1003. In a still further aspect, the polycarbonate blend has a haze measurement of less than or equal to about 3.0% when measured in accordance with ASTM D-1003. In a yet further aspect, the polycarbonate blend has a haze measurement of less than or equal to about 2.5% when measured in accordance with ASTM D-1003. In an even further aspect, the polycarbonate blend has a haze measurement of less than or equal to about 2.0% when measured in accordance with ASTM D-1003. In a still further aspect, the polycarbonate blend has a haze measurement of less than or equal to about 1.5% when measured in accordance with ASTM D-1003. In a yet further aspect, the polycarbonate blend has a haze measurement of less than or equal to about 1.0% when measured in accordance with ASTM D-1003.

In a further aspect, the polycarbonate blend has a transmission measurement of greater than or equal to about 80% when measured in accordance with ASTM D-1003. In a still further aspect, the polycarbonate blend has a transmission measurement of greater than or equal to about 82% when measured in accordance with ASTM D-1003. In a yet further aspect, the polycarbonate blend has a transmission measurement of greater than or equal to about 84% when measured in accordance with ASTM D-1003. In an even further aspect, the polycarbonate blend has a transmission measurement of greater than or equal to about 85% when measured in accordance with ASTM D-1003. In a still further aspect, the polycarbonate blend has a transmission measurement of greater than or equal to about 86% when measured in accordance with ASTM D-1003. In a yet further aspect, the polycarbonate blend has a transmission measurement of greater than or equal to about 88% when measured in accordance with ASTM D-1003. In an even further aspect, the polycarbonate blend has a transmission measurement of greater than or equal to about 90% when measured in accordance with ASTM D-1003.

In a further aspect, the polycarbonate blend has a UV absorbance of less than or equal to about 1.0 when measured at 280 nm on a 10 μm thickness film. In a still further aspect, the polycarbonate blend has a UV absorbance of less than or equal to about 0.9 when measured at 280 nm on a 10 μm thickness film. In a yet further aspect, the polycarbonate blend has a UV absorbance of less than or equal to about 0.8 when measured at 280 nm on a 10 μm thickness film. In an even further aspect, the polycarbonate blend has a UV absorbance of less than or equal to about 0.7 when measured at 280 nm on a 10 μm thickness film. In a still further aspect, the polycarbonate blend has a UV absorbance of less than or equal to about 0.6 when measured at 280 nm on a 10 μm thickness film. In a yet further aspect, the polycarbonate blend has a UV absorbance of less than or equal to about 0.5 when measured at 280 nm on a 10 μm thickness film. In an even further aspect, the polycarbonate blend has a UV absorbance of less than or equal to about 0.4 when measured at 280 nm on a 10 μm thickness film. In a still further aspect, the polycarbonate blend has a UV absorbance of less than or equal to about 0.3 when measured at 280 nm on a 10 μm thickness film. In a yet further aspect, the polycarbonate blend has a UV absorbance of less than or equal to about 0.2 when measured at 280 nm on a 10 μm thickness film. In an even further aspect, the polycarbonate blend has a UV absorbance of less than or equal to about 0.1 when measured at 280 nm on a 10 μm thickness film. In a still further aspect, the polycarbonate blend has a UV absorbance of less than or equal to about 0.05 when measured at 280 nm on a 10 μm thickness film.

In a further aspect, the heat deflection temperature is greater than or equal to about 140° C. when tested under a load of 0.45 MPa on molded plaques of 3.2 mm thickness in accordance with ISO 75. In a yet further aspect, the heat deflection temperature is greater than or equal to about 145° C. when tested under a load of 0.45 MPa on molded plaques of 3.2 mm thickness in accordance with ISO 75. In a still further aspect, the heat deflection temperature is greater than or equal to about 150° C. when tested under a load of 0.45 MPa on molded plaques of 3.2 mm thickness in accordance with ISO 75. In a yet further aspect, the heat deflection temperature is greater than or equal to about 155° C. when tested under a load of 0.45 MPa on molded plaques of 3.2 mm thickness in accordance with ISO 75. In an even further aspect, the heat deflection temperature is greater than or equal to about 160° C. when tested under a load of 0.45 MPa on molded plaques of 3.2 mm thickness in accordance with ISO 75. In a still further aspect, the heat deflection temperature is greater than or equal to about 165° C. when tested under a load of 0.45 MPa on molded plaques of 3.2 mm thickness in accordance with ISO 75. In a yet further aspect, the heat deflection temperature is greater than or equal to about 167° C. when tested under a load of 0.45 MPa on molded plaques of 3.2 mm thickness in accordance with ISO 75. In an even further aspect, the heat deflection temperature is greater than or equal to about 169° C. when tested under a load of 0.45 MPa on molded plaques of 3.2 mm thickness in accordance with ISO 75. In a still further aspect, the heat deflection temperature is greater than or equal to about 170° C. when tested under a load of 0.45 MPa on molded plaques of 3.2 mm thickness in accordance with ISO 75. In a yet further aspect, the heat deflection temperature is greater than or equal to about 171° C. when tested under a load of 0.45 MPa on molded plaques of 3.2 mm thickness in accordance with ISO 75. In an even further aspect, the heat deflection temperature is greater than or equal to about 172° C. when tested under a load of 0.45 MPa on molded plaques of 3.2 mm thickness in accordance with ISO 75. In a still further aspect, the heat deflection temperature is greater than or equal to about 173° C. when tested under a load of 0.45 MPa on molded plaques of 3.2 mm thickness in accordance with ISO 75. In a yet further aspect, the heat deflection temperature is greater than or equal to about 174° C. when tested under a load of 0.45 MPa on molded plaques of 3.2 mm thickness in accordance with ISO 75. In an even further aspect, the heat deflection temperature is greater than or equal to about 175° C. when tested under a load of 0.45 MPa on molded plaques of 3.2 mm thickness in accordance with ISO 75.

In a further aspect, the heat deflection temperature is greater than or equal to about 140° C. when tested under a load of 1.8 MPa in accordance with ISO 75. In a still further aspect, the heat deflection temperature is greater than or equal to about 145° C. when tested under a load of 1.8 MPa in accordance with ISO 75. In a yet further aspect, the heat deflection temperature is greater than or equal to about 150° C. when tested under a load of 1.8 MPa in accordance with ISO 75. In an even further aspect, the heat deflection temperature is greater than or equal to about 155° C. when tested under a load of 1.8 MPa in accordance with ISO 75. In a still further aspect, the heat deflection temperature is greater than or equal to about 156° C. when tested under a load of 1.8 MPa in accordance with ISO 75. In a yet further aspect, the heat deflection temperature is greater than or equal to about 157° C. when tested under a load of 1.8 MPa in accordance with ISO 75. In an even further aspect, the heat deflection temperature is greater than or equal to about 158° C. when tested under a load of 1.8 MPa in accordance with ISO 75. In a still further aspect, the heat deflection temperature is greater than or equal to about 159° C. when tested under a load of 1.8 MPa in accordance with ISO 75. In a yet further aspect, the heat deflection temperature is greater than or equal to about 160° C. when tested under a load of 1.8 MPa in accordance with ISO 75. In an even further aspect, the heat deflection temperature is greater than or equal to about 161° C. when tested under a load of 1.8 MPa in accordance with ISO 75. In a still further aspect, the heat deflection temperature is greater than or equal to about 162° C. when tested under a load of 1.8 MPa in accordance with ISO 75. In a yet further aspect, the heat deflection temperature is greater than or equal to about 163° C. when tested under a load of 1.8 MPa in accordance with ISO 75. In an even further aspect, the heat deflection temperature is greater than or equal to about 165° C. when tested under a load of 1.8 MPa in accordance with ISO 75.

In a further aspect, the polycarbonate blend further comprises at least one additive selected from thermal stabilizers, antioxidants, UV stabilizers, plasticizers, visual effect enhancers, extenders, antistatic agents, catalyst quenchers, mold releasing agents, fire retardants, blowing agents, impact modifiers and processing aids. In a still further aspect, the polycarbonate blend further comprises at least one additive selected from UV stabilizer, antioxidant, and mold releasing agent. In a yet further aspect, the polycarbonate blend further comprises a UV stabilizer. In an even further aspect, the polycarbonate blend further comprises an anti-oxidant. In all cases the additive is selected as to not significantly decrease the % transparency or increase the % haze or the yellowness (initial YI or delta YI after heat aging) of the polycarbonate blend.

In a further aspect, the polycarbonate blend further comprises a UV stabilizer selected from 2-(2H-benzotriazol-2-yl)-4-(1,1,3,3-tetramethylbutyl)-phenol; 2-(2H-benzotriazol-2-yl)-4-(tert-butyl)-6-(sec-butyl)phenol; 2-hydroxy-4-n-octyloxybenzophenone; 2-[4,6-bis(2,4-dimethylphenyl)-1,3,5-triazin-2-yl]-5-(octyloxy)-phenol; 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; and 2-(2H-benzotriazol-2-yl)-4,6-bis(1-methyl-1-phenylethyl)phenol. In a still further aspect, the UV stabilizer is the UV absorber is 2-(2H-benzotriazol-2-yl)-4,6-bis(1-methyl-1-phenylethyl)phenol. In a yet further aspect, the UV stabilizer is present in the polycarbonate blend in an amount within the range not to impair or degrade performance characteristics such as heat deflection temperature, strength (e.g. tensile strength, Izod impact strength and/or falling dart impact strength), yellowness index (e.g. initial yellowness index or the change in yellowness index upon heat aging), % transmission, UV absorbance, and the like. In an even further aspect, the UV stabilizer is present in the polycarbonate blend in an amount from about 0.0001 wt % to about 1.0 wt %.

In a further aspect, the polycarbonate blend further comprises an anti-oxidant selected from tris(nonyl phenyl)phosphate; tris(2,4-di-t-butylphenyl)phosphite; bis(2,4-di-t-butylphenyl)pentaerythritol diphosphite; distearyl pentaerythritol diphosphite; tetrakis[methylene(3,5-di-tert-butyl-4-hydroxyhydrocinnamate)]methane; distearylthiopropionate; dilaurylthiopropionate; ditridecylthiodipropionate; octadecyl-3-(3,5-di-tert-butyl-4-hydroxyphenyl)propionate; and pentaerythrityl-tetrakis[3-(3,5-di-tert-butyl-4-hydroxyphenyl)propionate. In a still further aspect, the antioxidant is tris(2,4-di-t-butylphenyl)phosphate. In a yet further aspect, the antioxidant is tetrakis[methylene(3,5-di-tert-butyl-4-hydroxyhydrocinnamate)]methane. In a yet further aspect, the anti-oxidant is present in the polycarbonate blend in an amount within the range not to impair or degrade performance characteristics such as heat deflection temperature, strength (e.g. tensile strength, Izod impact strength and/or falling dart impact strength), yellowness index (e.g. initial yellowness index or the change in yellowness index upon heat aging), % transmission, UV absorbance, and the like. In an even further aspect, the anti-oxidant is present in the polycarbonate blend in an amount from about 0.0001 wt % to about 1.0 wt %.

In a further aspect, the polycarbonate blend has a refractive index of less than or equal to about 1.61 when determined at 589.2 nanometers. In a still further aspect, the polycarbonate blend has a refractive index of less than or equal to about 1.62 when determined at 589.2 nanometers. In a yet further aspect, the polycarbonate blend has a refractive index of less than or equal to about 1.63 when determined at 589.2 nanometers. In an even further aspect, the polycarbonate blend has a refractive index of less than or equal to about 1.64 when determined at 589.2 nanometers. In a still further aspect, the polycarbonate blend has a refractive index of less than or equal to about 1.60 when determined at 589.2 nanometers. In a yet further aspect, the polycarbonate blend has a refractive index of less than or equal to about 1.59 when determined at 589.2 nanometers.

In various aspects, the invention relates to polycarbonate blends, the polycarbonate blend comprising: a polycarbonate polymer comprising about 0 mol % to about 10 mol % structural units derived from bisphenol A and about 90 mol % to about 100 mol % structural units derived from bisphenol acetophenone; wherein the yellowness index of the polycarbonate blend has an initial value of less than or equal to about 3.0 when tested in accordance with ASTM E313 on molded plaques of 3.2 mm thickness; wherein the yellowness index of the polycarbonate blend is less than or equal to about 6.0 at about 20 days and about 140° C. when tested in accordance with ASTM E313 on molded plaques of 3.2 mm thickness; and wherein the heat deflection temperature of the polycarbonate blend is greater than or equal to about 150° C. when tested under a load of 0.45 MPa on molded plaques of 3.2 mm thickness in accordance with ISO 75. In a further aspect, the polycarbonate blend further comprising a second polycarbonate comprising structural units derived from bisphenol A; wherein the polycarbonate polymer is present in an amount from about 10 wt % to about 100 wt %; and wherein the second polycarbonate is present in an amount from about 0 wt % to about 90 wt %.

In various aspects, the invention relates to polycarbonate blends, the polycarbonate blend comprising: from about 10 wt % to about 100 wt % of a first polycarbonate comprising about 10 mol % to 100 mol % structural units derived from bisphenol acetophenone and about 0 mol % to about 90 mol % structural units derived from bisphenol A; and from about 0 wt % to about 90 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to polycarbonate blends, the polycarbonate blend comprising: from about 90 wt % to about 100 wt % of a first polycarbonate comprising about 90 mol % to about 100 mol % structural units derived from bisphenol acetophenone and about 0 mol % to about 10 mol % structural units derived from bisphenol A; and from about 0 wt % to about 10 wt % of a second polycarbonate comprising bisphenol A monomer residues; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to polycarbonate blends, the polycarbonate blend comprising: about 90 wt % of a first polycarbonate comprising 90 mol % to about 100 mol % structural units derived from bisphenol acetophenone and about 0 mol % to about 10 mol % structural units derived from bisphenol A; and about 10 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to polycarbonate blends, the polycarbonate blend comprising: about 90 wt % of a first polycarbonate, wherein the first polycarbonate is a polycarbonate homopolymer comprising structural units derived from bisphenol acetophenone; and about 10 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to polycarbonate blends, the polycarbonate blend comprising: a polycarbonate homopolymer comprising structural units derived from bisphenol acetophenone; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to polycarbonate blends, the polycarbonate blend comprising: about 90 mol % to about 100 mol % structural units derived from bisphenol acetophenone and about 0 mol % to about 10 mol % structural units derived from bisphenol A; and wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75. In a further aspect, the polycarbonate blend further comprises a second polycarbonate, wherein the second polycarbonate is a polycarbonate polymer comprising bisphenol A monomer residues; wherein the polycarbonate copolymer is present in an amount from about 10 wt % to about 100 wt %; and wherein the second polycarbonate is present in an amount from about 0 wt % to about 90 wt %.

In various aspects, the invention relates to polycarbonate blends, the polycarbonate blend comprising: from about 10 wt % to about 100 wt % of a first polycarbonate comprising about 10 mol % to about 100 mol % structural units derived from bisphenol acetophenone and about 0 mol % to about 90 mol % structural units derived from bisphenol A; and from about 0 wt % to about 90 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising: a polycarbonate polymer comprising about 0 mol % to about 10 mol % structural units derived from bisphenol A and about 90 mol % to about 100 mol % structural units derived from bisphenol acetophenone; wherein the yellowness index of the polycarbonate blend has an initial value of less than or equal to about 3.0 when tested in accordance with ASTM E313 on molded plaques of 3.2 mm thickness; wherein the yellowness index of the polycarbonate blend is less than or equal to about 6.0 at about 20 days and about 140° C. when tested in accordance with ASTM E313 on molded plaques of 3.2 mm thickness; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029. In a further aspect, the polycarbonate blend further comprising a second polycarbonate comprising structural units derived from bisphenol A; wherein the polycarbonate polymer is present in an amount from about 10 wt % to about 100 wt %; and wherein the second polycarbonate is present in an amount from about 0 wt % to about 90 wt %.

In various aspects, the invention relates to polycarbonate blends, the polycarbonate blend comprising: from about 10 wt % to about 100 wt % of a first polycarbonate comprising about 10 mol % to 100 mol % structural units derived from bisphenol acetophenone and about 0 mol % to about 90 mol % structural units derived from bisphenol A; and from about 0 wt % to about 90 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested in accordance with ASTM D-3029 on molded plaques of 3.2 mm thickness.

In various aspects, the invention relates to polycarbonate blends, the polycarbonate blend comprising: from about 90 wt % to about 100 wt % of a first polycarbonate comprising about 90 mol % to about 100 mol % structural units derived from bisphenol acetophenone and about 0 mol % to about 10 mol % structural units derived from bisphenol A; and from about 0 wt % to about 10 wt % of a second polycarbonate comprising bisphenol A monomer residues; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising: about 90 wt % of a first polycarbonate comprising 90 mol % to about 100 mol % structural units derived from bisphenol acetophenone and about 0 mol % to about 10 mol % structural units derived from bisphenol A; and about 10 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising: about 90 wt % of a first polycarbonate, wherein the first polycarbonate is a polycarbonate homopolymer comprising structural units derived from bisphenol acetophenone; and about 10 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising: a polycarbonate homopolymer comprising structural units derived from bisphenol acetophenone; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising: about 90 mol % to about 100 mol % structural units derived from bisphenol acetophenone and about 0 mol % to about 10 mol % structural units derived from bisphenol A; and wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029. In a further aspect, the polycarbonate blend further comprises a second polycarbonate, wherein the second polycarbonate is a polycarbonate polymer comprising bisphenol A monomer residues; wherein the polycarbonate copolymer is present in an amount from about 10 wt % to about 100 wt %; and wherein the second polycarbonate is present in an amount from about 0 wt % to about 90 wt %.

In various aspects, the invention relates to polycarbonate blends, the polycarbonate blend comprising: from about 10 wt % to about 100 wt % of a first polycarbonate comprising about 10 mol % to about 100 mol % structural units derived from bisphenol acetophenone and about 0 mol % to about 90 mol % structural units derived from bisphenol A; wherein the first polycarbonate has a Mw of between about 20,000 Daltons and about 30,000 Daltons; and wherein the first polycarbonate has a Mn of between about 10,000 and about 20,000; and from about 0 wt % to about 90 wt % of a second polycarbonate comprising structural units derived from bisphenol A; wherein second polycarbonate has a Mw of between about 21,000 Daltons and about 31,000 Daltons; and wherein the second polycarbonate has a Mn of between about 10,500 and about 15,500; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising: a polycarbonate polymer comprising about 0 mol % to about 10 mol % structural units derived from bisphenol A and about 90 mol % to about 100 mol % structural units derived from bisphenol acetophenone; wherein the polycarbonate polymer has a Mw of between about 20,000 Daltons and about 30,000 Daltons; and wherein the first polycarbonate has a Mn of between about 10,000 and about 20,000; wherein the yellowness index of the polycarbonate blend has an initial value of less than or equal to about 3.0 when tested in accordance with ASTM E313 on molded plaques of 3.2 mm thickness; wherein the yellowness index of the polycarbonate blend is less than or equal to about 6.0 at about 20 days and about 140° C. when tested in accordance with ASTM E313 on molded plaques of 3.2 mm thickness; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029. In a further aspect, the polycarbonate blend further comprising a second polycarbonate comprising structural units derived from bisphenol A; wherein the polycarbonate polymer is present in an amount from about 10 wt % to about 100 wt %; and wherein the second polycarbonate is present in an amount from about 0 wt % to about 90 wt %.

In various aspects, the invention relates to polycarbonate blends, the polycarbonate blend comprising: from about 10 wt % to about 100 wt % of a first polycarbonate comprising about 10 mol % to 100 mol % structural units derived from bisphenol acetophenone and about 0 mol % to about 90 mol % structural units derived from bisphenol A; wherein the first polycarbonate has a Mw of between about 20,000 Daltons and about 30,000 Daltons; and wherein the first polycarbonate has a Mn of between about 10,000 and about 20,000; and from about 0 wt % to about 90 wt % of a second polycarbonate comprising structural units derived from bisphenol A; wherein second polycarbonate has a Mw of between about 21,000 Daltons and about 31,000 Daltons; and wherein the second polycarbonate has a Mn of between about 10,500 and about 15,500; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested in accordance with ASTM D-3029 on molded plaques of 3.2 mm thickness.

In various aspects, the invention relates to polycarbonate blends, the polycarbonate blend comprising: from about 90 wt % to about 100 wt % of a first polycarbonate comprising about 90 mol % to about 100 mol % structural units derived from bisphenol acetophenone and about 0 mol % to about 10 mol % structural units derived from bisphenol A; wherein the first polycarbonate has a Mw of between about 20,000 Daltons and about 30,000 Daltons; and wherein the first polycarbonate has a Mn of between about 10,000 and about 20,000; and from about 0 wt % to about 10 wt % of a second polycarbonate comprising bisphenol A monomer residues; wherein second polycarbonate has a Mw of between about 21,000 Daltons and about 31,000 Daltons; and wherein the second polycarbonate has a Mn of between about 10,500 and about 15,500; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising: about 90 wt % of a first polycarbonate comprising 90 mol % to about 100 mol % structural units derived from bisphenol acetophenone and about 0 mol % to about 10 mol % structural units derived from bisphenol A; wherein the first polycarbonate has a Mw of between about 20,000 Daltons and about 30,000 Daltons; and wherein the first polycarbonate has a Mn of between about 10,000 and about 20,000; and about 10 wt % of a second polycarbonate comprising structural units derived from bisphenol A; wherein second polycarbonate has a Mw of between about 21,000 Daltons and about 31,000 Daltons; and wherein the second polycarbonate has a Mn of between about 10,500 and about 15,500; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising: about 90 wt % of a first polycarbonate, wherein the first polycarbonate is a polycarbonate homopolymer comprising structural units derived from bisphenol acetophenone; wherein the first polycarbonate has a Mw of between about 20,000 Daltons and about 30,000 Daltons; and wherein the first polycarbonate has a Mn of between about 10,000 and about 20,000; and about 10 wt % of a second polycarbonate comprising structural units derived from bisphenol A; wherein second polycarbonate has a Mw of between about 21,000 Daltons and about 31,000 Daltons; and wherein the second polycarbonate has a Mn of between about 10,500 and about 15,500; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to polycarbonate blends, the polycarbonate blend comprising a polycarbonate homopolymer comprising structural units derived from bisphenol acetophenone; wherein the polycarbonate homopolymer has a Mw of between about 20,000 Daltons and about 30,000 Daltons; and wherein the first polycarbonate has a Mn of between about 10,000 and about 20,000; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029. In a further aspect, the polycarbonate blend further comprises a second polycarbonate, wherein the second polycarbonate is a polycarbonate polymer comprising bisphenol A monomer residues; wherein second polycarbonate has a Mw of between about 21,000 Daltons and about 31,000 Daltons; wherein the second polycarbonate has a Mn of between about 10,500 and about 15,500; wherein the polycarbonate homopolymer is present in an amount from about 10 wt % to about 100 wt %; and wherein the second polycarbonate is present in an amount from about 0 wt % to about 90 wt %.

In various aspects, the invention relates to polycarbonate blends, the polycarbonate blend comprising a polycarbonate polymer comprising about 90 mol % to about 100 mol % structural units derived from bisphenol acetophenone and about 0 mol % to about 10 mol % structural units derived from bisphenol A; wherein the polycarbonate polymer has a Mw of between about 20,000 Daltons and about 30,000 Daltons; and wherein the polycarbonate polymer has a Mn of between about 10,000 and about 20,000; and wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029. In a further aspect, the polycarbonate blend further comprises a second polycarbonate, wherein the second polycarbonate is a polycarbonate polymer comprising bisphenol A monomer residues; wherein second polycarbonate has a Mw of between about 21,000 Daltons and about 31,000 Daltons; wherein the second polycarbonate has a Mn of between about 10,500 and about 15,500; wherein the polycarbonate copolymer is present in an amount from about 10 wt % to about 100 wt %; and wherein the second polycarbonate is present in an amount from about 0 wt % to about 90 wt %.

In various aspects, described herein are articles made from the disclosed compositions. In one aspect, the invention relates to articles comprising a disclosed composition. In a further aspect, the article is used in automotive applications. In a still further aspect, the article is selected from selected from a motor vehicle headlamp lens, a motor vehicle fog lamp lens, a motor vehicle headlamp bezel, a medical device, a display device, a projector lens, a heat shield, a lighting source enclosure, and a lighting source lens. In a still further aspect, the display device is selected from a computer monitor screen, a laptop screen, a liquid crystal display screen, and an organic light-emitting diode screen. In an even further aspect, the automobile headlamp lens is selected from an outer headlamp lens and an inner headlamp lens. In a still further aspect, wherein the automobile headlamp lens is an automobile outer headlamp lens.

### Polycarbonate Polymer

As used herein, the term “polycarbonate” includes homopolycarbonates and copolycarbonates have repeating structural carbonate units. In one aspect, a polycarbonate can comprise any polycarbonate material or mixture of materials, for example, as recited in U.S. Pat. No. 7,786,246, which is hereby incorporated in its entirety for the specific purpose of disclosing various polycarbonate compositions and methods.

In one aspect, a polycarbonate, as disclosed herein, can be an aliphatic-diol based polycarbonate. In another aspect, a polycarbonate can comprise a carbonate unit derived from a dihydroxy compound, such as for example a bisphenol that differs from the aliphatic diol.

In various aspects, the polycarbonate can comprise copolymers comprising two or more distinct carbonate units. For example, a polycarbonate copolymer can comprise repeating carbonate units derived from BisAP and a second, chemically distinct dihydroxy monomer such as a bisphenol, e.g. bisphenol A. Alternatively, a polycarbonate copolymer can comprise repeating carbonate units derived from PPPBP and a second, chemically distinct dihydroxy monomer such as a bisphenol, e.g. bisphenol A.

In various aspects, polycarbonates disclosed herein have repeating structural carbonate units of the formula (1):

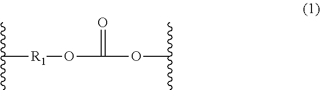

wherein at least 60 percent of the total number of R¹ groups contains aromatic organic groups and the balance thereof are aliphatic, alicyclic, or aromatic groups. “Polycarbonate” as used herein includes polymers homopolycarbonates and copolycarbonates (i.e. copolymers comprising different R¹ moieties in the polycarbonate).

In a further aspect, the R¹ group is a divalent aromatic group, derived from a dihydroxy aromatic compound of the formula (2):

HO-A¹-Y¹-A²-OH,

wherein each of A¹ and A² is a monocyclic divalent arylene group, and Y¹ is a single bond or a bridging group having one or two atoms that separate A¹ from A². In a still further aspect, one atom separates A¹ from A². In a yet further aspect, when each of A¹ and A² is phenylene, Y¹ is para to each of the hydroxyl groups on the phenylenes. In an even further aspect, non-limiting examples of these groups of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging group Y¹ can be a hydrocarbon group or a saturated hydrocarbon group such as methylene, cyclohexylidene, or isopropylidene.

In a further aspect, useful dihydroxy compounds have the formula (3):

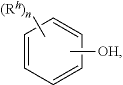

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. In a still further aspect, the halogen is usually bromine.

In a further aspect, dihydroxy aromatic compounds of formula (2) are bisphenol compounds of general formula (4):

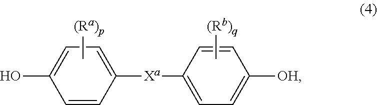

wherein R^{a} and R^{h} each represent a halogen atom or a monovalent hydrocarbon group and can be the same or different; p and q are each independently integers of 0 to 4; and X^{a} represents a single bond or a group of formulas (5):

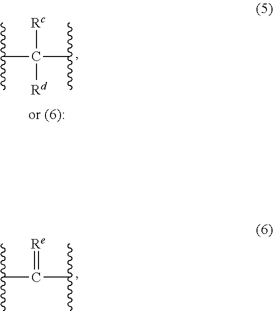

wherein R^{e} and R^{d} are each independently hydrogen, C1-12 alkyl, C1-12 cycloalkyl, C7-12 arylalkyl, C1-12 heteroalkyl, or cyclic C7-12 heteroarylalkyl, and Re is a divalent C1-12 hydrocarbon group. In an embodiment, R^{e} and R^{d} are each the same hydrogen or C1-4 alkyl group, specifically the same C1-3 alkyl group, even more specifically, methyl.

In a further aspect, R^{c} and R^{d} taken together represent a C₃₋₂₀ cyclic alkylene group or a heteroatom-containing C₃₋₂₀ cyclic alkylene group comprising carbon atoms and heteroatoms with a valency of two or greater. These groups can be in the form of a single saturated or unsaturated ring, or a fused polycyclic ring system wherein the fused rings are saturated, unsaturated, or aromatic. In a still further aspect, heteroatom-containing cyclic alkylene group comprises at least one heteroatom with a valency of 2 or greater, and at least two carbon atoms. For example, heteroatoms in the heteroatom-containing cyclic alkylene group include —O—, —S—, and —N(Z)—, wherein Z is a substituent group selected from hydrogen, hydroxy, C₁₋₁₂ alkyl, C₁₋₁₂alkoxy, or C₁₋₁₂ acyl.

In a further aspect, bisphenols (4) used in the preparation of polycarbonates comprising polycarbonphthalimidine carbonate repeating units of formula (4a):

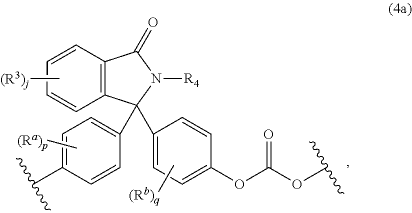

wherein R^{a}, R^{b}, p, and q are as in formula (4), R³ is each independently a C₁₋₆ alkyl group, j is 0 to 4, and R₄ is a C₁₋₆ alkyl, phenyl, or phenyl substituted with up to five C₁₋₆ alkyl groups. In a still further aspect, the phthalimidine carbonate repeating units comprises a residue of formula (4b):

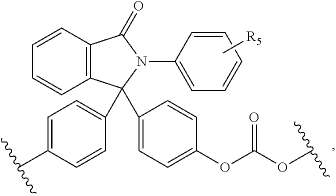

wherein R⁵ is hydrogen or a C₁₋₆ alkyl. In an embodiment, R⁵ is hydrogen. Carbonate units (4a) wherein R⁵ is hydrogen can be derived from 2-phenyl-3,3′-bis(4-hydroxy phenyl)phthalimidine (also known as N-phenyl phenolphthalein bisphenol, or “PPPBP”) (also known as 3,3-bis(4-hydroxyphenyl)-2-phenylisoindolin-1-one).

In a further aspect, the bisphenol carbonate comprises repeating units of this type are the isatin carbonate units of formula (4c):

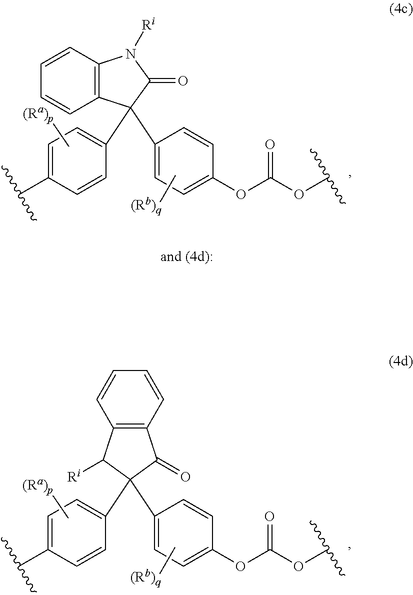

wherein R^{a} and R^{b} are each independently C₁₋₁₂ alkyl, p and q are each independently 0 to 4, and Rⁱ is C₁₋₁₂ alkyl, phenyl, optionally substituted with 1 5 to C₁₋₁₀ alkyl, or benzyl optionally substituted with 1 to 5 C₁₋₁₀ alkyl. In a still further aspect, R^{a} and R^{b} are each methyl, p and q are each independently 0 or 1, and R¹ is C₁₋₄ alkyl or phenyl.

In a further aspect, bisphenol carbonate repeating units comprise residues derived from bisphenols (4) wherein X^{b} is a substituted or unsubstituted C₃₋₁₈cycloalkylidene include the cyclohexylidene-bridged, alkyl-substituted bisphenol of formula (4e):

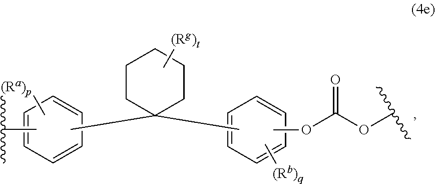

wherein R^{a} and R^{b} are each independently C₁₋₁₂ alkyl, R^{g} is C₁₋₁₂ alkyl, p and q are each independently 0 to 4, and t is 0 to 10. In a specific embodiment, at least one of each of R^{a} and R^{b} are disposed meta to the cyclohexylidene bridging group. In a still further aspect, R^{a} and R^{b} are each independently C₁₋₄ alkyl, R^{g} is C₁₋₄ alkyl, p and q are each 0 or 1, and t is 0 to 5. In a yet further aspect, R^{a}, R^{b}, and R^{g} are each methyl, r and s are each 0 or 1, and t is 0 or 3, specifically 0.

In a further aspect, bisphenol carbonate units comprise residues derived from bisphenol (4) wherein X^{b} is a substituted or unsubstituted C₃₋₁₈ cycloalkylidene include repeating units represented of formula (4f), or structural variations or analogs thereof:

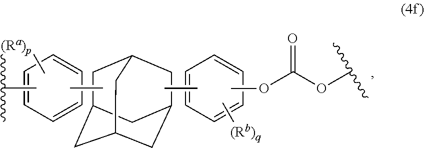

and repeating units of formula (4 g), or structural variations or analogs thereof:

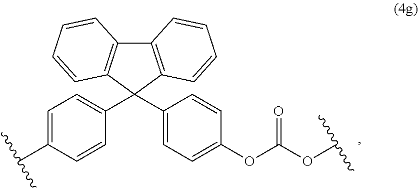

wherein R^{a} and R^{b} are each independently C₁₋₁₂ alkyl, and p and q are each independently 1 to 4. In a specific embodiment, at least one of each of R^{a} and R^{b} are disposed meta to the cycloalkylidene bridging group. In a still further aspect, R^{a} and R^{b} are each independently C₁₋₃ alkyl, and p and q are each 0 or 1. In a yet further aspect, R^{a}, R^{b} are each methyl, p and q are each 0 or 1. In various aspects, carbonates comprising units (4a) to (4 g) are useful for making polycarbonates of the present invention with high glass transition temperatures (Tg) and high heat distortion temperatures.

In one aspect, the bisphenol compound is selected from 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxy-3 methylphenyl)cyclohexane 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, or combinations comprising one or more of the foregoing dihydroxy aromatic compounds.

In a further aspect, the bisphenol compound comprises a compound selected from 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (“PPPBP”), 9,9-bis(4-hydroxyphenyl)fluorene, and,4′-(1-phenylethylidene)bisphenol; 1,1-bis(4-hydroxyphenyl)-1-phenylethane (“BisAP”), or combinations comprising one or more of the foregoing dihydroxy aromatic compounds. In a still further aspect, the bisphenol comprises combinations of one or more dihydroxy aromatic compound. In another aspect, other types of diols can be present in the polycarbonate.

In yet another aspect, polycarbonates with branching groups can be useful, provided that such branching does not significantly adversely affect desired properties of the polycarbonate. Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4-(4′-(1,1-bis(p-hydroxyphenyl)-ethyl)alpha,alpha-dimethylbenzyl)phenol), 4-chloroformyl phthalic anhydride, trimesic acid, and benzophenone tetracarboxylic acid. In one aspect, a branching agent can be added at a level of about 0.05 to about 2.0 wt %. In still another aspect, mixtures comprising linear polycarbonates and branched polycarbonates can be used.

In various aspects, polycarbonates useful in the present invention comprise a diol component including a compound represented by formula (5):

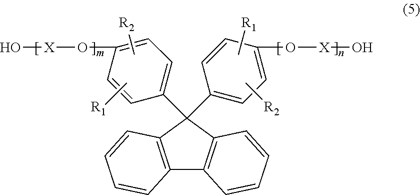

and a fluorine-containing carbonate are subjected to melt polycondensation. In the context of formula (5), R¹ and R² are each independently a hydrogen atom, C1-10 alkyl group, C6-10 cycloalkyl group, or C6-10 aryl group, and two of R¹ and two of R² may mutually be the same or different; X is a C1-6 alkylene group, C6-10 cycloalkylene group, or C6-10 arylene group, and a plurality of X may be the same or different; and m and n are each independently an integer between 1 and 5.

In various further aspects, polycarbonates useful in the present invention comprise a diol component including a compound represented by formula (6):

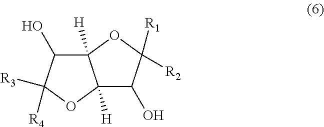

and a fluorine-containing carbonate are subjected to melt polycondensation. R¹ through R⁴ are each independently a hydrogen atom, C1-10 alkyl group (optionally containing etheric oxygen), C6-10 cycloalkyl group (optionally containing etheric oxygen), or C6-10 aryl group (optionally containing etheric oxygen), and R¹ through R⁴ can mutually be the same or different.

In various further aspects, polycarbonates and copolycarbonates useful in the present invention comprise units derived from bisphenols represented by formulas (7) and (8):

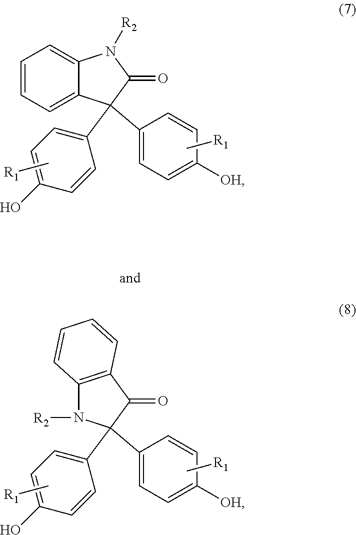

wherein each R¹ is independently selected from hydrogen or a C1-C10-alkyl and R² is C1-C10-alkyl, or phenyl or benzyl in each case unsubstituted or substituted by at least one member selected from the group consisting of hydrogen and C1-C10-alkyl radical.

In various further aspects, polycarbonates useful in the present invention are disclosed in WO2011062121, WO2011062104, JP20050206834, JP2011089050, JP2011029051, US20110151262, U.S. Pat. No. 5,344,910, and U.S. Pat. No. 7,547,755.

In one aspect, polycarbonates can be manufactured using an interfacial phase transfer process or melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium such as for example methylene chloride, and contacting the reactants with a carbonate precursor (such as phosgene) in the presence of a catalyst such as, for example, triethylamine or a phase transfer catalyst salt, under controlled pH conditions of, for example, from about 8 to about 10.

The polycarbonate compounds and polymers disclosed herein can, in various aspects, be prepared by a melt polymerization process. Generally, in the melt polymerization process, polycarbonates are prepared by co-reacting, in a molten state, the dihydroxy reactant(s) (i.e., isosorbide, aliphatic diol and/or aliphatic diacid, and any additional dihydroxy compound) and a diaryl carbonate ester, such as diphenyl carbonate, or more specifically in an aspect, an activated carbonate such as bis(methyl salicyl)carbonate, in the presence of a transesterification catalyst. The reaction can be carried out in typical polymerization equipment, such as one or more continuously stirred reactors (CSTRs), plug flow reactors, wire wetting fall polymerizers, free fall polymerizers, wiped film polymerizers, BANBURY® mixers, single or twin screw extruders, or combinations of the foregoing. In one aspect, volatile monohydric phenol can be removed from the molten reactants by distillation and the polymer is isolated as a molten residue.

The melt polymerization can include a transesterification catalyst comprising a first catalyst, also referred to herein as an alpha catalyst, comprising a metal cation and an anion. In an aspect, the cation is an alkali or alkaline earth metal comprising Li, Na, K, Cs, Rb, Mg, Ca, Ba, Sr, or a combination comprising at least one of the foregoing. The anion is hydroxide (OH⁻), superoxide (O²⁻), thiolate (HS⁻), sulfide (S²⁻), a C₁₋₂₀ alkoxide, a C₆₋₂₀ aryloxide, a C₁₋₂₀ carboxylate, a phosphate including biphosphate, a C₁₋₂₀ phosphonate, a sulfate including bisulfate, sulfites including bisulfites and metabisulfites, a C₁₋₂₀ sulfonate, a carbonate including bicarbonate, or a combination comprising at least one of the foregoing. In another aspect, salts of an organic acid comprising both alkaline earth metal ions and alkali metal ions can also be used. Salts of organic acids useful as catalysts are illustrated by alkali metal and alkaline earth metal salts of formic acid, acetic acid, stearic acid and ethyelenediaminetetraacetic acid. The catalyst can also comprise the salt of a non-volatile inorganic acid. By “nonvolatile”, it is meant that the referenced compounds have no appreciable vapor pressure at ambient temperature and pressure. In particular, these compounds are not volatile at temperatures at which melt polymerizations of polycarbonate are typically conducted. The salts of nonvolatile acids are alkali metal salts of phosphites; alkaline earth metal salts of phosphites; alkali metal salts of phosphates; and alkaline earth metal salts of phosphates. Exemplary transesterification catalysts include, lithium hydroxide, sodium hydroxide, potassium hydroxide, cesium hydroxide, magnesium hydroxide, calcium hydroxide, barium hydroxide, lithium formate, sodium formate, potassium formate, cesium formate, lithium acetate, sodium acetate, potassium acetate, lithium carbonate, sodium carbonate, potassium carbonate, lithium methoxide, sodium methoxide, potassium methoxide, lithium ethoxide, sodium ethoxide, potassium ethoxide, lithium phenoxide, sodium phenoxide, potassium phenoxide, sodium sulfate, potassium sulfate, NaH₂PO₃, NaH₂PO₄, Na₂H₂PO₃, KH₂PO₄, CsH₂PO₄, Cs₂H₂PO₄, Na₂SO₃, Na₂S₂O₅, sodium mesylate, potassium mesylate, sodium tosylate, potassium tosylate, magnesium disodium ethylenediaminetetraacetate (EDTA magnesium disodium salt), or a combination comprising at least one of the foregoing. It will be understood that the foregoing list is exemplary and should not be considered as limited thereto. In one aspect, the transesterification catalyst is an alpha catalyst comprising an alkali or alkaline earth salt. In an exemplary aspect, the transesterification catalyst comprises sodium hydroxide, potassium hydroxide, sodium carbonate, potassium carbonate, sodium methoxide, potassium methoxide, NaH₂PO₄, or a combination comprising at least one of the foregoing.

The amount of alpha catalyst can vary widely according to the conditions of the melt polymerization, and can be about 0.001 to about 500 μmol. In an aspect, the amount of alpha catalyst can be about 0.01 to about 20 μmol, specifically about 0.1 to about 10 μmol, more specifically about 0.5 to about 9 μmol, and still more specifically about 1 to about 7 μmol, per mole of aliphatic diol and any other dihydroxy compound present in the melt polymerization.

In another aspect, a second type of transesterification catalyst, also referred to herein as a beta catalyst, can be included as the catalyst or in combination with the alpha catalyst in the melt polymerization process, provided that the inclusion of such a second transesterification catalyst does not significantly adversely affect the desirable properties of the polycarbonate. Exemplary transesterification catalysts can further include a combination of catalysts of formula (R³)₄Q⁺X above, wherein each R³ is the same or different, and is a C₁₋₁₀alkyl group; Q is a nitrogen or phosphorus atom; and X is a halogen atom or a C₁₋₈ alkoxy group or C₆₋₁₈ aryloxy group. Exemplary salts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing. Other melt transesterification catalysts include alkaline earth metal salts or alkali metal salts. In various aspects, where a beta catalyst is desired, the beta catalyst can be present in a molar ratio, relative to the alpha catalyst, of less than or equal to 10, specifically less than or equal to 5, more specifically less than or equal to 1, and still more specifically less than or equal to 0.5. In other aspects, the melt polymerization reaction disclosed herein uses only an alpha catalyst as described hereinabove, and is substantially free of any beta catalyst. As defined herein, “substantially free of” can mean where the beta catalyst has been excluded from the melt polymerization reaction. In one aspect, the beta catalyst is present in an amount of less than about 10 ppm, specifically less than 1 ppm, more specifically less than about 0.1 ppm, more specifically less than or equal to about 0.01 ppm, and more specifically less than or equal to about 0.001 ppm, based on the total weight of all components used in the melt polymerization reaction.

In one aspect, an end-capping agent (also referred to as a chain-stopper) can optionally be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned.

In another aspect, endgroups can be derived from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In one aspect, the endgroup of a polycarbonate, including a polycarbonate polymer as defined herein, can comprise a structural unit derived from a diaryl carbonate, where the structural unit can be an endgroup. In a further aspect, the endgroup is derived from an activated carbonate. Such endgroups can be derived from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups.

In one aspect, the melt polymerization reaction can be conducted by subjecting the reaction mixture to a series of temperature-pressure-time protocols. In some aspects, this involves gradually raising the reaction temperature in stages while gradually lowering the pressure in stages. In one aspect, the pressure is reduced from about atmospheric pressure at the start of the reaction to about 1 millibar (100 Pa) or lower, or in another aspect to 0.1 millibar (10 Pa) or lower in several steps as the reaction approaches completion. The temperature can be varied in a stepwise fashion beginning at a temperature of about the melting temperature of the reaction mixture and subsequently increased to final temperature. In one aspect, the reaction mixture is heated from room temperature to about 150° C. In such an aspect, the polymerization reaction starts at a temperature of about 150° C. to about 220° C. In another aspect, the polymerization temperature can be up to about 220° C. In other aspects, the polymerization reaction can then be increased to about 250° C. and then optionally further increased to a temperature of about 320° C., and all subranges there between. In one aspect, the total reaction time can be from about 30 minutes to about 200 minutes and all subranges there between. This procedure will generally ensure that the reactants react to give polycarbonates with the desired molecular weight, glass transition temperature and physical properties. The reaction proceeds to build the polycarbonate chain with production of ester-substituted alcohol by-product such as methyl salicylate. In one aspect, efficient removal of the by-product can be achieved by different techniques such as reducing the pressure. Generally the pressure starts relatively high in the beginning of the reaction and is lowered progressively throughout the reaction and temperature is raised throughout the reaction.

In one aspect, the progress of the reaction can be monitored by measuring the melt viscosity or the weight average molecular weight of the reaction mixture using techniques known in the art such as gel permeation chromatography. These properties can be measured by taking discrete samples or can be measured on-line. After the desired melt viscosity and/or molecular weight is reached, the final polycarbonate product can be isolated from the reactor in a solid or molten form. It will be appreciated by a person skilled in the art, that the method of making aliphatic homopolycarbonate and aliphatic-aromatic copolycarbonates as described in the preceding sections can be made in a batch or a continuous process and the process disclosed herein is preferably carried out in a solvent free mode. Reactors chosen should ideally be self-cleaning and should minimize any “hot spots.” However, vented extruders similar to those that are commercially available can be used.

In addition to the polycarbonate, thermoplastic composition can include various additives ordinarily incorporated in resin compositions of this type, with the proviso that the additives are selected so as to not significantly adversely affect the desired properties of thermoplastic composition. Combinations of additives can be used. Such additives can be mixed at a suitable time during the mixing of the components for forming the composition.

In other aspects, a polycarbonate composition can comprise one or more of an antioxidant, for instance, phosphorous containing stabilizers and hindered phenols, flame retardant, heat stabilizer, light stabilizer, UV absorbing additive, plasticizer, lubricant, mold release agent, antistatic agent, colorant (e.g., pigment and/or dye), or a combination thereof.

The compositions of the present invention can be blended with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between about 230° C. and about 350° C. in the molten resin composition, although higher temperatures can be used provided that the residence time of the resin in the processing equipment is kept short. In some embodiments the melt processed composition exits processing equipment such as an extruder through small exit holes in a die. The resulting strands of molten resin are cooled by passing the strands through a water bath. The cooled strands can be chopped into small pellets for packaging and further handling.

Thermoplastic compositions comprising blended polycarbonate compositions can be manufactured by various methods. For example, powdered polycarbonate, other polymer (if present), and/or other optional components are first blended, optionally with fillers in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming

### Optional Polycarbonate Blend Additives

In other aspects, the inventive polycarbonate blend can comprise one or more other materials that can maintain and/or improve optical and other properties of the resulting material. In various aspects, the polycarbonate blend can further comprise at least one additive selected from thermal stabilizers, antioxidants, UV stabilizers, plasticizers, visual effect enhancers, extenders, antistatic agents, catalyst quenchers, mold releasing agents, fire retardants, blowing agents, impact modifiers and processing aids. In a further aspect, the polycarbonate blend further comprises at least one additive selected from UV stabilizer, antioxidant, and mold releasing agent. For example, the disclosed compositions of the invention can also be combined with various additives including, but not limited to, stabilizers or antioxidants such as hindered phenols, phosphites, phosphonites, thioesters and mixtures thereof, as well as mold release agents, lubricants, flame retardants, smoke suppressors and anti-drip agents, for example, those based on fluoropolymers. Alternatively, the additives may include, but are not limited to, fillers, antioxidants, lubricants, flame retardants, ultraviolet absorbers, ultraviolet stabilizers, processing aids, viscosity control agents, and the like, or a combination containing at least one of the foregoing, depending on the final selected characteristics of the compositions.

In addition to the polycarbonate blends of the present invention, the polycarbonate blends can include various additives ordinarily incorporated in resin compositions of this type, with the proviso that the additives are selected so as to not significantly adversely affect the desired properties of thermoplastic composition. Combinations of additives can be used. Such additives can be mixed at a suitable time during the mixing of the components for forming the composition.

In a further aspect, the composition can further comprise an antioxidant in an amount from about 0.001 pph to about 0.500 pph. In a yet further aspect, the antioxidant is selected from hindered phenols, phosphites, phosphonites, thioesters and any mixture thereof.

Use of phosphonate or phosphite compounds or mixtures thereof may be desired in some instances to improve color and oxidative stability. In another instance triaryl phosphonate, phosphite compounds or mixtures thereof may be employed. Effective amounts of the additives vary widely, but they are usually present in an amount up to about 0.01-20% or more by weight, based on the weight of the entire composition. Flame retardants based on sulfonate salts, such a perfluoro alky metal sulfonates, aryl sulfonate salts or mixtures thereof, aryl phosphates and halogenated aromatic compounds may be useful. Ultraviolet light stabilizers can also be added to the compositions in effective amounts. Preferred mold release agents are alkyl carboxylic acid esters, for example, pentaerythritol tetrastearate, glycerin tristearate and ethylene glycol distearate. Mold release agents are typically present in the composition at 0.01-0.5% by weight of the formulation. Other examples of mold release agents are may also be alpha-olefins or low molecular weight poly alpha olefins, or blends thereof.

Examples of antioxidants include, but are not limited to, hindered phenols such as tetrakis[methylene(3,5-di-t-butyl-4-hydroxyhydrocinnamate)]-methane, 4,4′-thiobis(2-methyl-6-tert-butylphenol), and thiodiethylene bis(3,5-di-tert-butyl-4-hydroxy)hydrocinnamate, octadecyl-3(3.5-di-tertbutyl-4-hydroxyphenyl)propionate, pentaerythritoltetrakis(3(3.5-di-tertbutyl-4-hydroxyphenyl)propionate), phosphites and phosphonites such as tris(2,4-di-tert-butylphenyl)phosphite and thio compounds such as dilauryl thiodipropionate, dimyristyl thiodipropionate, and distearyl thiodipropionate, potassium iodide, cuprous iodide, various siloxanes, and amines such as polymerized 2,2,4-trimethyl-1,2-dihydroquinoline and the like, or a combination containing at least one of the foregoing.

The disclosed thermoplastic compositions may further comprise a primary antioxidant or “stabilizer” (e.g., a hindered phenol and/or secondary aryl amine) and, optionally, a secondary antioxidant (e.g., a phosphate and/or thioester). Suitable antioxidant additives include, for example, organic phosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of about 0.01 to about 1 parts by weight, optionally about 0.05 to about 0.5 parts by weight, based on 100 parts by weight of the blend composition of polycarbonate, primary and secondary impact modifier.

In a further aspect, the anti-oxidant is selected from tris(nonyl phenyl)phosphate; tris(2,4-di-t-butylphenyl)phosphite; bis(2,4-di-t-butylphenyl)pentaerythritol diphosphite; distearyl pentaerythritol diphosphite; tetrakis[methylene(3,5-di-tert-butyl-4-hydroxyhydrocinnamate)]methane; distearylthiopropionate; dilaurylthiopropionate; ditridecylthiodipropionate; octadecyl-3-(3,5-di-tert-butyl-4-hydroxyphenyl)propionate; and pentaerythrityl-tetrakis[3-(3,5-di-tert-butyl-4-hydroxyphenyl)propionate. In a still further aspect, the antioxidant is tris(2,4-di-t-butylphenyl)phosphate. In a yet further aspect, the antioxidant is tetrakis[methylene(3,5-di-tert-butyl-4-hydroxyhydrocinnamate)]methane. In various aspects, the anti-oxidant is present in the polycarbonate blend in an amount from about 0.0001 wt % to about 1.0 wt %.

Light stabilizers and/or ultraviolet light (UV) absorbing additives (“UV absorber”) can also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of about 0.01 to about 10 parts by weight, optionally about 0.1 to about 1 parts by weight, based on 100 parts by weight of the blend composition of polycarbonate, primary and secondary impact modifier.

Suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers. UV absorbers are generally used in amounts of about 0.1 to about 5 parts by weight, based on 100 parts by weight of the blend composition of polycarbonate, primary and secondary impact modifier. In a further aspect, the UV absorber is present in the polycarbonate blend in an amount from about 0.0001 wt % to about 1.0 wt %.

In various aspects, the UV absorber is selected from 2-(2H-benzotriazol-2-yl)-4-(1,1,3,3-tetramethylbutyl)-phenol; 2-(2H-benzotriazol-2-yl)-4-(tert-butyl)-6-(sec-butyl)phenol; 2-hydroxy-4-n-octyloxybenzophenone; 2-[4,6-bis(2,4-dimethylphenyl)-1,3,5-triazin-2-yl]-5-(octyloxy)-phenol; 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; and 2-(2H-benzotriazol-2-yl)-4,6-bis(1-methyl-1-phenylethyl)phenol. In a still further aspect, the UV absorber is 2-(2H-benzotriazol-2-yl)-4,6-bis(1-methyl-1-phenylethyl)phenol.

Plasticizers, lubricants, and/or mold release agents additives may also be used. There is considerable overlap among these types of materials, which include, for example, phthalic acid esters such as dioctyl-4,5-epoxy-hexahydrophthalate; tris(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylenepolypropylene glycol copolymers in a suitable solvent; waxes such as beeswax, montan wax, paraffin wax or the like. Such materials are generally used in amounts of about 0.1 to about 20 parts by weight, optionally about 1 to about 10 parts by weight, based on 100 parts by weight of the blend composition of polycarbonate, primary and secondary impact modifier.

### Manufacture of Blended Polycarbonate Compositions

In various aspects, the blended polycarbonate compositions of the present invention can be manufactured by various methods. The compositions of the present invention can be blended with the aforementioned ingredients by a variety of methods involving intimate admixing of the materials with any additional additives desired in the formulation. Because of the availability of melt blending equipment in commercial polymer processing facilities, melt processing methods can be used. In various further aspects, the equipment used in such melt processing methods includes, but is not limited to, the following: co-rotating and counter-rotating extruders, single screw extruders, co-kneaders, disc-pack processors and various other types of extrusion equipment. In a further aspect, the extruder is a twin-screw extruder. In various further aspects, the melt processed composition exits processing equipment such as an extruder through small exit holes in a die. The resulting strands of molten resin are cooled by passing the strands through a water bath. The cooled strands can be chopped into small pellets for packaging and further handling.

The temperature of the melt is minimized in order to avoid excessive degradation of the resins. For example, it can be desirable to maintain the melt temperature between about 230° C. and about 350° C. in the molten resin composition, although higher temperatures can be used provided that the residence time of the resin in the processing equipment is kept short. In a still further aspect, the extruder is typically operated at a temperature of about 180° C. to about 385° C. In a yet further aspect, the extruder is typically operated at a temperature of about 200° C. to about 330° C. In an even further aspect, the extruder is typically operated at a temperature of about 220° C. to about 300° C.

In various aspects, the blended polycarbonate compositions of the present invention can be prepared by blending the first polycarbonate polymer, the second polycarbonate polymer, the impact modifier, the flow promoter, the flame retardant, and any polymer composition additive, e.g. a HENSCHEL-Mixer® high speed mixer or other suitable mixer/blender. Other low shear processes, including but not limited to hand mixing, can also accomplish this blending. The mixture can then be fed into the throat of a single or twin screw extruder via a hopper. Alternatively, at least one of the components can be incorporated into the composition by feeding directly into the extruder at the throat and/or downstream through a sidestuffer. Additives can also be compounded into a masterbatch desired polymeric resin and fed into the extruder. The extruder generally operated at a temperature higher than that necessary to cause the composition to flow. The extrudate is immediately quenched in a water bath and pelletized. The pellets, so prepared, when cutting the extrudate can be one-fourth inch long or less as desired. Such pellets can be used for subsequent molding, shaping, or forming.

### Articles

In various aspects, the disclosed polycarbonate blends with improved heat resistance of the present invention can be used in making articles. The disclosed blended polycarbonate compositions can be formed into useful shaped articles by a variety of means such as; injection molding, extrusion, rotational molding, compression molding, blow molding, sheet or film extrusion, profile extrusion, gas assist molding, structural foam molding and thermoforming. The blended polycarbonate compositions described herein resins can also be made into film and sheet as well as components of laminate systems. In a further aspect, a method of manufacturing an article comprises melt blending the first polycarbonate, the second polycarbonate, and optional polycarbonate blend additives; and molding the extruded composition into an article. In a still further aspect, the extruding is done with a single screw extruder or a twin screw extruder.

Formed articles include, for example, a motor vehicle headlamp lens, a motor vehicle fog lamp lens, a motor vehicle headlamp bezel, a medical device, a display device, a projector lens, a heat shield, a lighting source enclosure, and a lighting source lens, and the like. In various further aspects, formed articles include, but are not limited to, display devices selected from a computer monitor screen, a laptop screen, a liquid crystal display screen, and an organic light-emitting diode screen. In a further aspect, articles of the present invention comprise an automobile headlamp lens. In a still further aspect, articles of the present invention comprise an outer headlamp lens and an inner headlamp lens. In a yet further aspect, articles of the present invention comprise an outer headlamp lens.

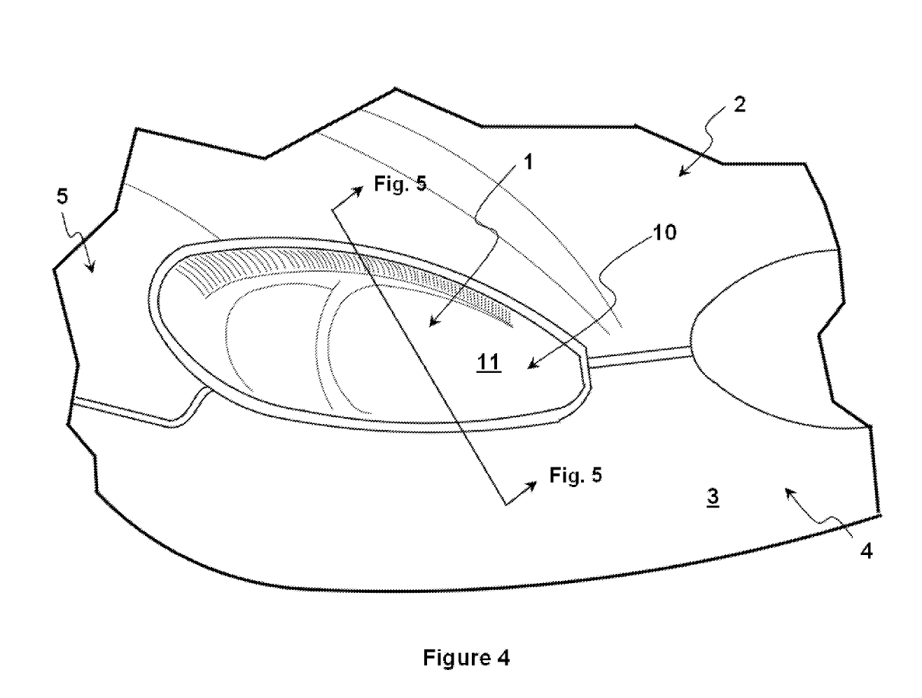

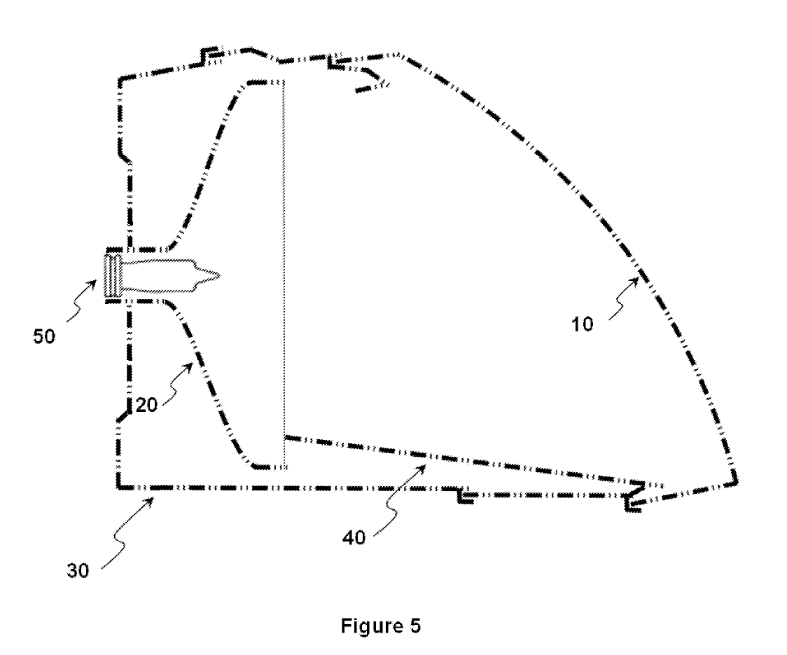

In various aspects, the articles of the present invention such as a motor vehicle headlamp or a motor vehicle headlamp assembly comprise a lens, a bezel, a housing, and a reflector. In one aspect, a headlamp assembly can be described in part in FIGS. 4 and 5, and the description thereof herein. The right front quadrant of a vehicle, e.g. an automobile, is shown in FIG. 4. The automobile includes a bumper 4 having an outer surface 3 which can be flush with the surface 11 of the lens 10 of the headlamp assembly 1. The vehicle hood 2 can extend around a portion of the outer periphery of the lens 10, as does the right front fender 5. The articles of the present invention as they relate to motor vehicle headlamps, headlamp lens, and/or headlamp assemblies has application to other vehicle and headlamp designs to that shown in FIG. 4. For example, the articles of the present invention can be motor vehicle headlamps, headlamp lens, and/or headlamp assemblies wherein bumper(s) and/or other body parts extend beyond the lens or wherein the overall design geometry is distinct from that shown in FIG. 4, e.g. a circular lens, polygonal lens (including square or rectangular), or oval lens shapes.

FIG. 5 shows a cross-section of assembly 1 roughly along the line depicted in FIG. 4. The generally oval lens 10 of FIG. 4 (and shown in cross-section in FIG. 5) comprises the polycarbonate blends of the present invention, which may further comprise the optional polycarbonate additives as described hereinbefore. The lens 10, depending on the particular motor vehicle, e.g. automobile, may be fitted to the headlamp housing 30 as determined by the overall design considerations of the particular motor vehicle. In one aspect, as shown in FIG. 5, the lens 10 can fit into a flange and glue track of the headlamp bezel 40 and headlamp housing 30. The flanges are shaped to conform and mate with one another to provide a continuous junction between the lens 10 and member 40. The flange groove is filled with a suitable bonding adhesive, such as a urethane or silicone, to bond the lens 10 to the integrated flexural member 40. The headlamp assembly further comprises a reflector 20 and a light source 50. The light source can be any of number of currently accepted lighting technologies, e.g. halogen, high-intensity discharge (“HID”) and light-emitting diode (“LED”).

The volume enclosed within the headlamp assembly (i.e. the interior volume) will depend upon the particular motor vehicle and the design considerations thereof. For example, the interior volume can be about 300, 400, 500, 600, 700, 800, 900, 1000, 1100, 1200, 1300, 1400, 1500, 1600, 1700, 1800, 1900 and 2000 cm³. In a further aspect, the interior volume is about 750 to about 1200 cm³. The loading, which as used herein refers to the watts dissipated in a given volume and has the units watts per cubic centimeter (W/cm³), is about 0.020, about 0.030, about 0.040, about 0.050, about 0.060, about 0.070, about 0.080, about 0.090, or about 0.100 W/cm³ (which may be alternatively expressed as 2.0%, 3.0%, 4.0%, 5.0%, 6.0%, 7.0%, 8.0%, 9.0% or 10%). In a further aspect, the polycarbonate blends of the present invention, and the articles comprising the disclosed blends, can be used in applications wherein the loading is about 0.020, about 0.030, about 0.040, about 0.050, about 0.060, about 0.070, about 0.080, about 0.090, or about 0.100 W/cm³. In a still further aspect, the delta yellowness index (“dYI”) has a change of less than or equal to about 1.0, about 2.0, about 3.0, about 4.0, about 5.0, about 6.0 or about 7.0 when exposed to about 200 hours to a light source and interior volume such that the loading is about 0.020, about 0.030, about 0.040, about 0.050, about 0.060, about 0.070, about 0.080, about 0.090, or about 0.100 W/cm³, or the equivalent heat aging from a non-light emitting source.

In one aspect, the present invention pertains to articles comprising the disclosed blended polycarbonate compositions. In various aspects, the article comprising the disclosed blended polycarbonate compositions is used in applications requiring a heat resistant polycarbonate with high optical clarity and color stability.

In a further aspect, the article is selected from selected from a motor vehicle headlamp lens, a motor vehicle fog lamp lens, a motor vehicle headlamp bezel, a medical device, a display device, a projector lens, a heat shield, a lighting source enclosure, and a lighting source lens. In a still further aspect, the display device is selected from a computer monitor screen, a laptop screen, a liquid crystal display screen, and an organic light-emitting diode screen. In a yet further aspect, the display device is selected from a computer monitor screen, a laptop screen, a liquid crystal display screen, and an organic light-emitting diode screen. In a still further aspect, the automobile headlamp lens is selected from an outer headlamp lens and an inner headlamp lens. In a yet further aspect, wherein the automobile headlamp lens is an automobile outer headlamp lens.

In various aspects, the article of the present invention comprises a polycarbonate blend, the polycarbonate blend comprising: from about 10 wt % to about 100 wt % of a first polycarbonate comprising about 10 mol % to about 100 mol % structural units derived from bisphenol acetophenone and about 0 mol % to about 90 mol % structural units derived from bisphenol A; and from about 0 wt % to about 90 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In a further aspect, the article is a headlamp assembly comprising: a headlamp lens comprising the polycarbonate blend; a headlamp reflector, wherein the headlamp reflector comprises a polycarbonate blend composition comprising one or more polycarbonates selected from a bisphenol isophorone polycarbonate; a polycarbonate comprising structural units derived from 2-phenyl-3,3-bis(hydroxyphenyl)phthalimidine; a polycarbonate comprising structural units derived from bisphenol TMC; a polycarbonate comprising structural units derived from 9,9 bis(4-hydroxyphenyl)fluorene; and a polycarbonate comprising structural units derived from 2,2-bis(4-hydroxyphenyl)adamantine. a bezel; and a housing.

In a further aspect, the headlamp assembly further comprises a tungsten-halogen, a halogen infrared reflective, or a high-intensity discharge light source. In a still further aspect, the headlamp assembly comprises a tungsten-halogen light source. In a yet further aspect, the headlamp assembly comprises a high-intensity discharge source.

In a further aspect, the article comprises: a headlamp lens comprising the polycarbonate blend; and a headlamp reflector comprising a high heat polycarbonate composition; wherein the high heat polycarbonate composition has a heat deflection temperature of greater than or equal to about 150° C. when tested under a load of 0.45 MPa on molded plaques of 3.2 mm thickness in accordance with ISO 75. In a still further aspect, the high heat polycarbonate composition comprises a bisphenol isophorone polycarbonate. In a yet further aspect, the high heat polycarbonate composition comprises a polycarbonate comprising structural units derived from 2-phenyl-3,3-bis(hydroxyphenyl)phthalimidine. In an even further aspect, the high heat polycarbonate composition comprises a polycarbonate comprising structural units derived from bisphenol TMC. In a still further aspect, the polycarbonate composition comprises a polycarbonate composition comprising structural units derived from dihydroxyaryl fluorene and derivatives or analogs thereof. In a yet further aspect, the dihydroxyaryl fluorene is 9,9 bis(4-hydroxyphenyl)fluorene. In an even further aspect, the high heat polycarbonate composition comprises structural units derived from adamantyl bisphenol and derivatives or analogs thereof. In a still further aspect, the adamantyl bisphenol is 2,2-bis(4-hydroxyphenyl)adamantine.

In various aspects, the invention relates to an article comprising a polycarbonate blend, the polycarbonate blend comprising: a polycarbonate polymer comprising about 0 mol % to about 10 mol % structural units derived from bisphenol A and about 90 mol % to about 100 mol % structural units derived from bisphenol acetophenone; wherein the yellowness index of the polycarbonate blend has an initial value of less than or equal to about 3.0 when tested in accordance with ASTM E313 on molded plaques of 3.2 mm thickness; wherein the yellowness index of the polycarbonate blend is less than or equal to about 6.0 at about 20 days and about 140° C. when tested in accordance with ASTM E313 on molded plaques of 3.2 mm thickness; and wherein the heat deflection temperature of the polycarbonate blend is greater than or equal to about 150° C. when tested under a load of 0.45 MPa on molded plaques of 3.2 mm thickness in accordance with ISO 75. In a further aspect, the polycarbonate blend further comprising a second polycarbonate comprising structural units derived from bisphenol A; wherein the polycarbonate polymer is present in an amount from about 10 wt % to about 100 wt %; and wherein the second polycarbonate is present in an amount from about 0 wt % to about 90 wt %.

In various aspects, the invention relates to an article comprising a polycarbonate blend, the polycarbonate blend comprising: from about 10 wt % to about 100 wt % of a first polycarbonate comprising about 10 mol % to 100 mol % structural units derived from bisphenol acetophenone and about 0 mol % to about 90 mol % structural units derived from bisphenol A; and from about 0 wt % to about 90 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested in accordance with ASTM D-3029 on molded plaques of 3.2 mm thickness.

In various aspects, the invention relates to an article comprising a polycarbonate blend, the polycarbonate blend comprising: a polycarbonate polymer comprising from about 0 mol % to about 10 mol % structural units derived from bisphenol A and about 90 mol % to about 100 mol % structural units derived from bisphenol acetophenone; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested in accordance with ASTM D-3029 on molded plaques of 3.2 mm thickness.

In various aspects, the invention relates to a headlamp lens comprising a polycarbonate blend, the polycarbonate blend comprising: from about 90 wt % to about 100 wt % of a first polycarbonate comprising about 90 mol % to about 100 mol % structural units derived from bisphenol acetophenone and about 0 mol % to about 10 mol % structural units derived from bisphenol A; and from about 0 wt % to about 10 wt % of a second polycarbonate comprising bisphenol A monomer residues; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to a headlamp lens comprising a polycarbonate blend, the polycarbonate blend comprising: about 90 wt % of a first polycarbonate comprising 90 mol % to about 100 mol % structural units derived from bisphenol acetophenone and about 0 mol % to about 10 mol % structural units derived from bisphenol A; and about 10 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to a headlamp lens comprising a polycarbonate blend, the polycarbonate blend comprising: about 90 wt % of a first polycarbonate, wherein the first polycarbonate is a polycarbonate homopolymer comprising structural units derived from bisphenol acetophenone; and about 10 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to a headlamp lens comprising a polycarbonate blend, the polycarbonate blend comprising: a polycarbonate homopolymer comprising structural units derived from bisphenol acetophenone; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75. In a further aspect, the polycarbonate blend further comprises a second polycarbonate, wherein the second polycarbonate is a polycarbonate polymer comprising bisphenol A monomer residues; wherein the polycarbonate copolymer is present in an amount from about 10 wt % to about 100 wt %; and wherein the second polycarbonate is present in an amount from about 0 wt % to about 90 wt %.

In various aspects, the invention relates to a headlamp lens comprising a polycarbonate polymer, the polycarbonate polymer comprising: about 90 mol % to about 100 mol % structural units derived from bisphenol acetophenone and about 0 mol % to about 10 mol % structural units derived from bisphenol A; and wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; and wherein the heat deflection temperature of the polycarbonate blend is greater than or equal to about 150° C. when tested under a load of 0.45 MPa on molded plaques of 3.2 mm thickness in accordance with ISO 75.

In various aspects, the invention relates to a headlamp lens comprising a polycarbonate blend or a polycarbonate polymer as disclosed hereinbefore, and further comprising at least one additive selected from thermal stabilizers, antioxidants, UV stabilizers, plasticizers, visual effect enhancers, extenders, antistatic agents, catalyst quenchers, mold releasing agents, fire retardants, blowing agents, impact modifiers and processing aids. In a further aspect, the headlamp lens further comprises at least one additive selected from UV stabilizer, antioxidant, and mold releasing agent.

In a further aspect, the invention relates to a headlamp lens comprising a polycarbonate blend or a polycarbonate polymer as disclosed hereinbefore, and further comprising a UV absorber selected from 2-(2H-benzotriazol-2-yl)-4-(1,1,3,3-tetramethylbutyl)-phenol; 2-(2H-benzotriazol-2-yl)-4-(tert-butyl)-6-(sec-butyl)phenol; 2-hydroxy-4-n-octyloxybenzophenone; 2-[4,6-bis(2,4-dimethylphenyl)-1,3,5-triazin-2-yl]-5-(octyloxy)-phenol; 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; and 2-(2H-benzotriazol-2-yl)-4,6-bis(1-methyl-1-phenylethyl)phenol. In a still further aspect, the UV absorber is 2-(2H-benzotriazol-2-yl)-4,6-bis(1-methyl-1-phenylethyl)phenol. In a yet further aspect, the UV absorber is present in the polycarbonate blend in an amount from about 0.0001 wt % to about 1.0 wt %.

In a further aspect, the invention relates to a headlamp lens comprising a polycarbonate blend or a polycarbonate polymer as disclosed hereinbefore, and further comprising an anti-oxidant is selected from tris(nonyl phenyl)phosphate; tris(2,4-di-t-butylphenyl)phosphite; bis(2,4-di-t-butylphenyl)pentaerythritol diphosphite; distearyl pentaerythritol diphosphite; tetrakis[methylene(3,5-di-tert-butyl-4-hydroxyhydrocinnamate)]methane; distearylthiopropionate; dilaurylthiopropionate; ditridecylthiodipropionate; octadecyl-3-(3,5-di-tert-butyl-4-hydroxyphenyl)propionate; and pentaerythrityl-tetrakis[3-(3,5-di-tert-butyl-4-hydroxyphenyl)propionate. In a still further aspect, the antioxidant is tris(2,4-di-t-butylphenyl)phosphate. In a yet further aspect, the antioxidant is tetrakis[methylene(3,5-di-tert-butyl-4-hydroxyhydrocinnamate)]methane. In an even further aspect, the anti-oxidant is present in the polycarbonate blend in an amount from about 0.0001 wt % to about 1.0 wt %.

In various aspects, the invention relates to a headlamp lens comprising a polycarbonate blend, the polycarbonate blend comprising: about 90 wt % of a first polycarbonate comprising about 90 mol % to about 100 mol % structural units derived from bisphenol acetophenone and about 0 mol % to about 10 mol % structural units derived from bisphenol A; and about 10 wt % of a second polycarbonate polymer comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to a headlamp lens comprising a polycarbonate blend, the polycarbonate blend comprising: about 90 wt % of a polycarbonate homopolymer comprising structural units derived from bisphenol acetophenone; and about 10 wt % of a second polycarbonate comprising structural units derived from bisphenol A; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to a headlamp lens comprising a polycarbonate blend, the polycarbonate blend comprising: a polycarbonate homopolymer comprising structural units derived from bisphenol acetophenone; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to a headlamp lens comprising a polycarbonate polymer, the polycarbonate polymer comprising: about 90 mol % to about 100 mol % structural units derived from bisphenol acetophenone and about 0 mol % to about 10 mol % structural units derived from bisphenol A; and wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature is greater than or equal to about 140° C. when tested under a load of 0.45 MPa on molded plaques of 3.2 mm thickness in accordance with ISO 75; wherein the transmission measurement is greater than or equal to about 85% when measured in accordance with ASTM D-1003; and wherein the falling dart impact strength is greater than or equal to about 70 J when tested on molded plaques of 3.2 mm thickness in accordance with ASTM D-3029.

In various aspects, the invention relates to a headlamp lens comprising a polycarbonate homopolymer, the polycarbonate homopolymer comprising structural units derived from bisphenol acetophenone; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to a headlamp lens comprising a polycarbonate blend, the polycarbonate blend comprising: about 90 wt % of a first polycarbonate, wherein the first polycarbonate comprises about 90 mol % to about 100 mol % structural units derived from bisphenol acetophenone and about 0 mol % to about 10 mol % structural units derived from bisphenol A; wherein the first polycarbonate has a Mw of between about 20,000 Daltons and about 30,000 Daltons; and wherein the first polycarbonate has a Mn of between about 10,000 and about 20,000; and about 10 wt % of a second polycarbonate comprising structural units derived from bisphenol A; wherein second polycarbonate has a Mw of between about 21,000 Daltons and about 31,000 Daltons; and wherein the second polycarbonate has a Mn of between about 10,500 and about 15,500; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to a headlamp lens comprising a polycarbonate blend, the polycarbonate blend comprising: about 90 wt % a polycarbonate homopolymer comprising structural units derived from bisphenol acetophenone; wherein the polycarbonate homopolymer has a Mw of between about 20,000 Daltons and about 30,000 Daltons; and wherein the polycarbonate homopolymer has a Mn of between about 10,000 and about 20,000; and about 10 wt % of a second polycarbonate comprising structural units derived from bisphenol A; and wherein polycarbonate polymer has a Mw of between about 21,000 Daltons and about 31,000 Daltons; and wherein the polycarbonate polymer has a Mn of between about 10,500 and about 15,500; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to a headlamp lens comprising a polycarbonate blend, the polycarbonate blend comprising a polycarbonate homopolymer comprising structural units derived from bisphenol acetophenone; wherein the polycarbonate homopolymer has a Mw of between about 20,000 Daltons and about 30,000 Daltons; and wherein the polycarbonate homopolymer has a Mn of between about 10,000 and about 20,000; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to a headlamp lens comprising a polycarbonate blend, the polycarbonate blend comprising a polycarbonate polymer comprising: about 90 mol % to about 100 mol % structural units derived from bisphenol acetophenone and about 0 mol % to about 10 mol % structural units derived from bisphenol A; and wherein the polycarbonate polymer has a Mw of between about 20,000 Daltons and about 30,000 Daltons; and wherein the polycarbonate polymer has a Mn of between about 10,000 and about 20,000; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

In various aspects, the invention relates to a headlamp lens comprising a polycarbonate blend, the polycarbonate blend comprising a polycarbonate homopolymer comprising structural units derived from bisphenol acetophenone monomer residues; wherein the polycarbonate homopolymer has a Mw of between about 20,000 Daltons and about 30,000 Daltons; and wherein the polycarbonate homopolymer has a Mn of between about 10,000 and about 20,000; wherein the yellowness index of the polycarbonate blend has an initial value of less than or equal to about 3.0 when tested on molded plaques of 3.2 mm thickness in accordance with ASTM E313; wherein the delta yellowness index of the polycarbonate blend is less than or equal to about 6.0 after heat aging in air at about 140° C. for about 20 days when tested on molded plaques of 3.2 mm thickness in accordance with ASTM E313; wherein the heat deflection temperature of the polycarbonate blend is greater than or equal to about 150° C. when tested under a load of 0.45 MPa on molded plaques of 3.2 mm thickness in accordance with ISO 75; wherein the transmission measurement of the polycarbonate blend is greater than or equal to about 85% when measured in accordance with ASTM D-1003; and wherein the falling dart impact strength of the polycarbonate blend is greater than or equal to about 70 J when tested on molded plaques of 3.2 mm thickness in accordance with ASTM D-3029.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### EXAMPLES

The following examples are put forth so as to provide those of ordinary skill in the art with a complete disclosure and description of how the methods, devices, and systems disclosed and claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in degrees Celsius (° C.) or is at ambient temperature, and pressure is at or near atmospheric.

The materials shown in Table 1 were used to prepare the compositions described herein (labeled as “Sample 1” and “Sample 2”) and various comparator samples (labeled as “Comp. 1,” “Comp. 2,” and the like) which are further described herein. Molded articles were prepared for analysis. First, pellets of the polycarbonates described in Table I were prepared using a 28 mm twin-screw extruder, followed by injection molding using a Van Dorn molding machine having a clamping capacity of 85 ton, a screw diameter of 30 mm, and shot capacity of 3 ounces.

There are numerous variations and combinations of reaction conditions, e.g., component concentrations, desired solvents, solvent mixtures, temperatures, pressures and other reaction ranges and conditions that can be used to optimize the product purity and yield obtained from the described process.

Heat deflection temperature was determined per ISO 75 or ASTM D648 under a load of 0.45 MPa or 1.8 MPa (as indicated) using a specimen of 3.2 mm thickness. Data below are provided in ° C.

The yellowness index (“YI”) was determined per ASTM E313 on plaques of 50 mm×75 mm color chips with a 3.2 mm thickness which were molded on an 85 ton injection molding machine. The YI was determined using Gretag Macbeth ColorEye 7000A. The samples were aged in a hot air circulated oven at 140° C. and for time periods indicated below. The YI of the aged samples were compared to the YI of as-molded specimens to determine the YI shift (“dYI”).

UV-Vis spectroscopy was used to quantify the absorbance properties of the polymer film samples of 10 μm. A UV/Vis spectrometer Lambda 900 from PerkinElmer® Instruments, the software UV Winlab Version 3.00.03 and the following settings were used: absorbance spectra: from 380 nm to 720 nm in intervals of 10 nm with integration 1.0 nm intervals at a scan speed: 483.8 nm/min.

Haze and % transmission were measured in accordance with ASTM D-1003 on plaques of 50 mm×75 mm color chips with a 3.2 mm thickness which were molded as described above. “% light transmission” (or simply, “% transmission”) is the ratio of transmitted light to incident light directed onto the plaque and “haze” is the percentage of transmitted light which, in passing through the plaque, deviates from the incident beam by forward scattering.

Melt volume flow rate (“MVR”) was determined per the test method of ASTM D1238 under the following test conditions: a) 260° C./2.16 kg; and b) 260° C./5 kg at a dwell time of 360 s and 1080 s (abusive condition). Data below are provided for MVR in cm³/10 min.

The glass transition temperature (“Tg”) was determined by differential scanning calorimetry (“DSC”) run at a temperature ramp rate of 20° C./min in air. Data are provided below in ° C.

The notched Izod impact (“NII”) and unnotched Izod impact (“UNII”) tests were carried out on 2.5 inch×0.50 inch×0.125 inch molded samples (bars) according to ISO180 or ASTM D256 at 23° C. using a 2 lb hammer or 5 lb hammer, respectively. Test samples were aged at the indicated temperature for 24 hr prior to the test. Both impact strength (kJ/m² or Jim) and ductility were determined.

Multiaxial impact (“MAT”) was determined per ASTM D3763 at 22° C./3.4 m/s using a 4 inch Dynatup specimen of 3.2 mm thickness. The following parameters were determined: energy to maximum load (given in J); energy to failure (given in J); total energy (given in J); and ductility.

Flexural properties (modulus and strength) were measured using 3.2 mm bars in accordance with ASTM D790. Flexural strength (“Flex Strength”) is reported at yield (in units of MPa).

Tensile properties (modulus, strength, and elongation) were measured on 3.2 mm bars in accordance with ASTM D638 with a 5 mm/min crosshead speed. Tensile strength (in units of MPa) and tensile elongation (%) is reported at break.

TABLE 1

| Abbreviation | Description | Source |
|---|---|---|
| PC1 | Blend of BisAP polycarbonate resin (prepared as | SABIC |
| | described herein below) and a BPA polycarbonate resin | Innovative |
| | (PC4) comprising 90 wt % and 10 wt %, respectively. | Plastics |
| | | (“SABIC-IP”) |
| PC2 | BisAP polycarbonate resin prepared as described below. | SABIC-IP |
| PC3 | Polyphthalate carbonate resin (Lexan ® PPC4701) made | SABIC-IP |
| | by a condensation process with a MFR at 300° C./1.2 kg, | |
| | of about 2.00 to about 10 g/10 min when according to | |
| | ASTM D 1238 and a Mw of about 21,000 to about | |
| | 31,000. | |
| PC4 | BPA polycarbonate resin (Lexan ® PC 243R) made by a | SABIC-IP |
| | condensation process with a MFR at 300° C./1.2 kg, of | |
| | about 5.0 to about 10.5 g/10 min when according to | |
| | ASTM D 1238 and a Mw of about 20,000 to about | |
| | 31,000. | |
| PC5 | Bisphenol A/1,1-bis-(4-hydroxyphenyl)-3,3,5- | Bayer |
| | trimethylcyclohexane copolycarbonate resin (Apec ® | Material |
| | 2095/7 grade) having a melt volume rate of about 8 g/10 min | Science |
| | when measured according to ISO 1133; 330° C., | (“BMS”) |
| | 2.16 kg. | |
| PC6 | Bisphenol A/bisphenol 3,3,5-trimethylcyclohexanone | BMS |
| | copolycarbonate resin (Apec ® 1895/7 grade) having a | |
| | melt volume rate of about 18 g/10 min when measured | |
| | according to ISO 1133; 330° C., 2.16 kg. | |

Briefly, the general BisAP copolycarbonate resin synthesis was carried out by interfacial polymerization, and specifically as described hereinafter. Bisphenol-A and BisAP monomer (example amounts and end-capping amounts) were weighed and then transferred to a formulation tank which contained methylene chloride, water, triethylamine and aqueous sodium gluconate. The mixture was agitated for about 5 minutes and then transferred to a polymerization reactor. To the reaction mixture was added phosgene over the course of 25 minutes. p-Cumylphenol, an end-capping agent, was added to the reactor over the course of five minutes during the phosgenation reaction. Aqueous sodium hydroxide is co-added in order to control reaction pH. During this process it is important that the pH remain at 8.0 to minimize polymer dispersity (see Table 2 below).

TABLE 2

| | Polymer dispersity |
|---|---|
| pH | (Mw/Mn) |
| 10.5 | 4.6 |
| 10.0 | 3.45 |
| 9.5 | 3.3 |
| 9.0 | 2.8 |
| 8.0 | 2.6 |

After completion of the polymerization the reaction mixture is discharged to the centrifuge feed tank. The polymer solution is purified by feeding the reaction product to a train of liquid/liquid centrifuges. The first centrifuge stage separates the reaction by product brine from the resin solution. The second centrifuge stage removes catalyst from the resin solution by washing with dilute aqueous hydrochloric acid. The third centrifuge stage removes residual ionic species by washing the resin solution with water.

The purified resin solution is then concentrated by evaporation of methylene chloride. The resin is precipitated by co-feeding the resin solution to a jet with steam to flash off the methylene chloride. Residual methylene chloride is removed from the resin by counter current contact with steam. Excess water is removed from the resin using heated air in a fluidizing dryer.

The data indicated in Tables 4 and 5 were obtained on molded samples (e.g. plaques or bars of appropriate dimension as described for the specific test methods). The representative samples of the invention are: 1) samples designated “Sample 1” were molded using PC1; and 2) samples designated “Sample 2) were molded using PC2. The comparative samples were molded from the indicated polycarbonates as follows: 1) “Comp. 1” (or comparative sample 1) was molded using PC3; 2) “Comp. 2” (or comparative sample 2) was molded using PC4; 3) “Comp. 3” (or comparative sample 3) was molded using PC5; and 4) “Comp. 4” (or comparative sample 4) was molded using PC6. The descriptions of the representative samples are summarized in Table 3 below.

TABLE 3
Description

| | |
|---|---|
| Sample 1 | Blend of BisAP polycarbonate resin (prepared as described |
| | herein above) and a BPA polycarbonate resin comprising |
| | 90 wt % and 10 wt %, respectively. |
| Sample 2 | 100 wt % BisAP polycarbonate resin (prepared as |
| | described herein above). |
| Comp. 1 | 100 wt % Polyphthalate carbonate resin (Lexan ® PPC4701; |
| | see PC3 in Table 1). |
| Comp. 2 | 100 wt % BPA polycarbonate resin (Lexan ® PC 243R; |
| | see PC4 in Table 1). |
| Comp. 3 | 100 wt % Bisphenol A/1,1-bis-(4-hydroxyphenyl)-3,3,5- |
| | trimethylcyclohexane copolycarbonate resin (Apec ® 2095/7 |
| | grade; see PC5 in Table 1). |
| Comp. 4 | 100 wt % Bisphenol A/bisphenol |
| | 3,3,5-trimethylcyclohexanone copolycarbonate |
| | (Apec ® 1895/7 grade; see PC6 in Table 1). |

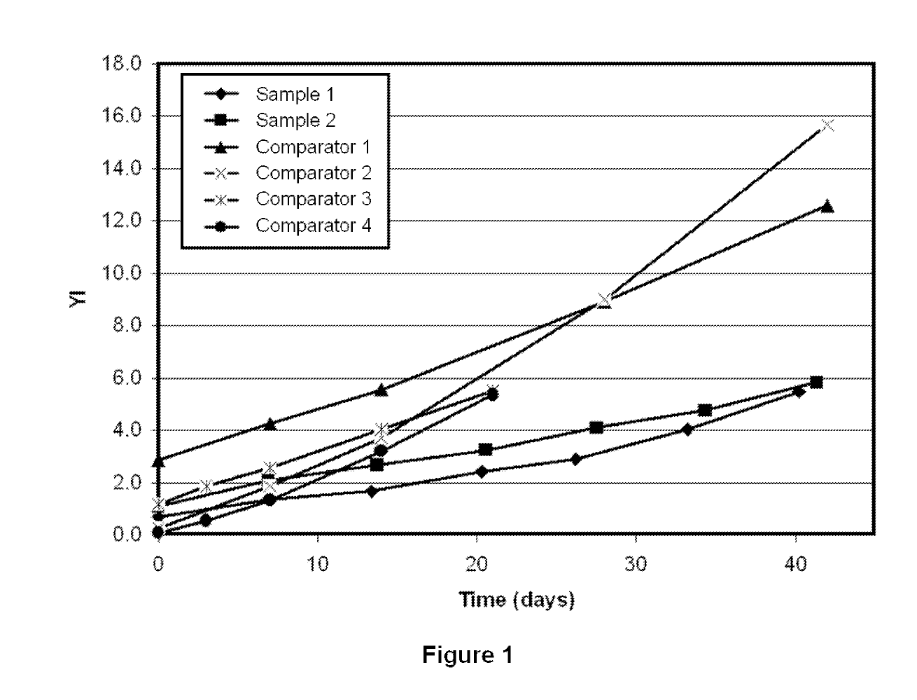

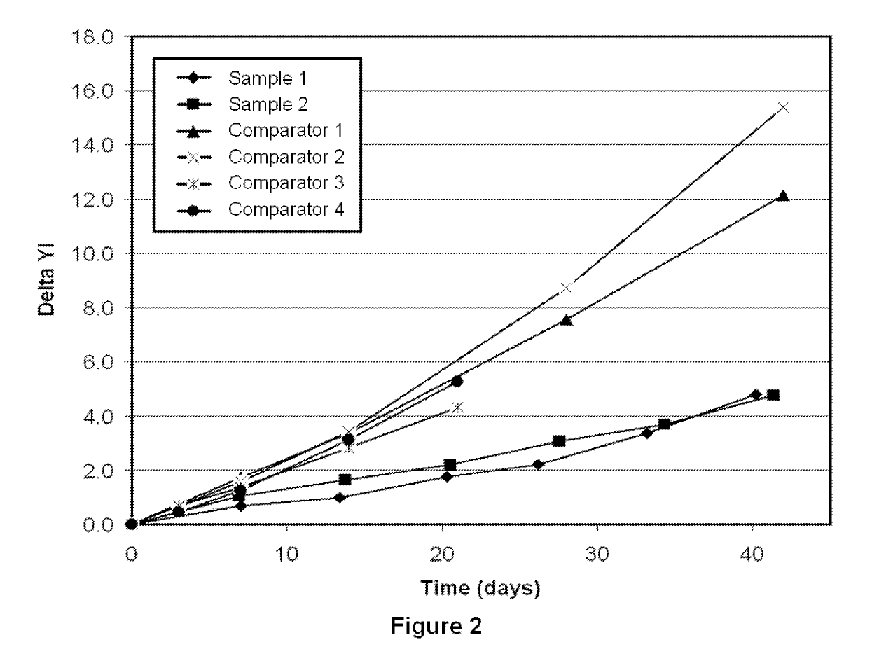

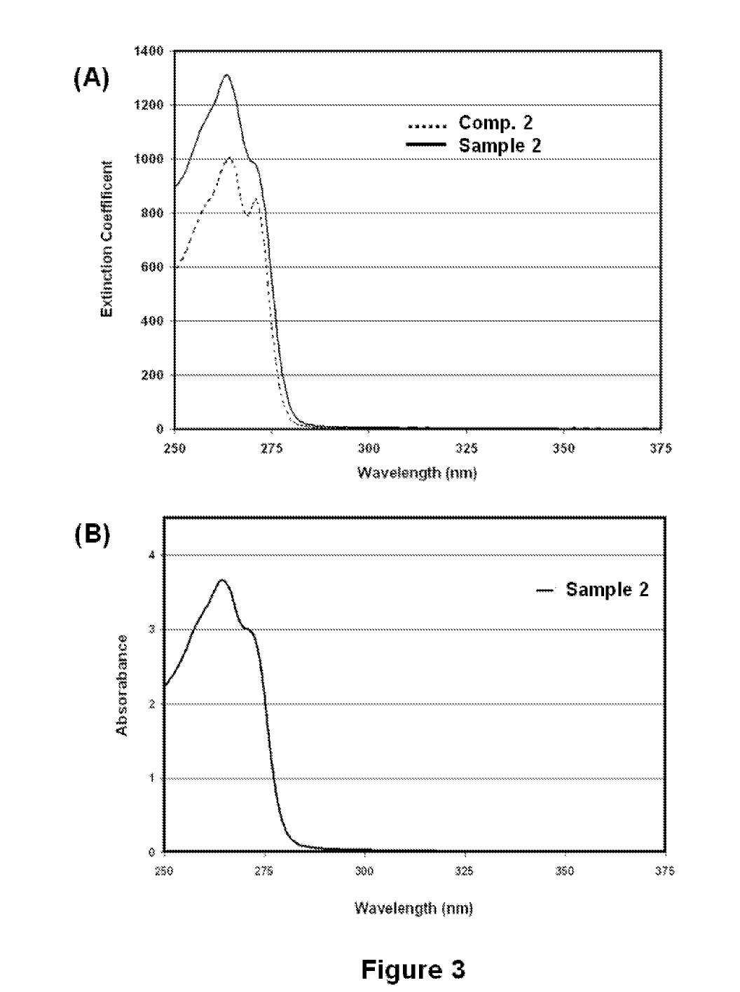

Flow and physical property comparisons between these different formulations are documented in Tables 4 and 5. As can be seen in the two samples (Sample 1 and Sample 2), the use of BisAP in either a blend or as a homopolymer, when compared to a standard BPA polycarbonate (Comp. 2) resulted in a significant increase in heat deflection temperature and glass transition temperature, whereas tensile and flexural properties, melt volume flow rate, multi-axial impact strength, and Izod impact strength (notched or unnotched) remained roughly the same. Properties related to clarity and color, i.e. YI and absorbance (see FIGS. 1-3), for Samples 1 and 2 showed significant improvement compared to a standard BPA polycarbonate (Comp. 2). In particular, the stability of YI, i.e. dYI, when a sample is subjected to aging at elevated temperature (140° C.), showed a marked improvement (comparison of Samples 1 and 2 to Comp. 2; see FIGS. 1 and 2). Moreover, the absorbance of Sample 2 showed almost no absorbance from about 290 nm to about 350 nm, whereas the standard BPA polycarbonate demonstrated significant absorbance in this same wavelength range (FIG. 3).

Comparison of Samples 1 and 2 to representative high heat polycarbonates (Comp. 1-4) shows that the blends of the present invention had improvement in a number of key properties. For example, the initial YI and the change in YI (dYI) when aged at elevated temperature (140° C.) demonstrated that Samples 1 and 2 have a much lower YI and very little change out to at least 40 days of aging under these conditions (FIGS. 1 and 2). In contrast, all comparative samples (Comp. 1-4) had a higher initial YI value, and significant change upon aging under these conditions. Heat related properties (Tg and HDT) were comparable between Samples 1 and 2 versus the comparative samples (Comp. 1-4). In contrast, Sample 2 showed a significant improvement in melt volume flow rate (“MVR”) and MAI ductility compared to a representative comparative high heat polycarbonate, Comp. 3. Tensile and flexural properties, multi-axial impact strength, and Izod impact strength were comparable between Sample 2 and Comp. 3.

The representative blends of the present invention demonstrated significant improvement in increased MVR, decreased initial YI and little change in YI under elevated temperature compared to comparative high heat polycarbonates, while maintaining desirable properties of tensile and flexural properties, Izod impact strength, HDT, and multi-axial impact strength when compared to these high heat polycarbonates. When compared to a standard BPA polycarbonate, the representative blends of the present invention demonstrated decreased absorbance in the UV range, improved Tg, and significantly improved HDT, whereas properties related to strength (tensile and flexural), impact strength (multi-axial and Izod), and melt volume flow rate (“MVR”) were comparable.

TABLE 4

| | Sample | Sample | Comp. | Comp. | Comp. | Comp. |
|---|---|---|---|---|---|---|
| Test* | 1 | 2 | 1 | 2 | 3 | 4 |
| Tg (DSC) | 180° C. | 185° C. | 180° C. | 148° C. | 182° C. | 206° C. |
| HDT ** | 153° C. | 160° C. | 148° C. | 132° C. | 159° C. | 176° C. |

*Carried out as described herein.
** Determined under a load of 1.8 MPa.

TABLE 5

| Test* | Unit | Sample 2 | Comp. 3 |
|---|---|---|---|
| % Trans. | — | 88% | 88% |
| % Haze | — | 0.5% | 0.5% |
| HDT (0.45 MPa) | ° C. | 174 | 172 |
| MAI - Energy to | J | 65.8 | 74.6 |
| max. load | | | |
| MAI - Energy to | J | 69.9 | 77.8 |
| failure | | | |
| MAI - Energy | J | 69.9 | 77.8 |
| (total) | | | |
| MAI - ductility | % | 100 | 80 |
| Tensile modulus | MPa | 2,692 | 2,350 |
| Tensile strength | MPa | 56.5 | 76.5 |
| Tensile elongation | % | 42.1 | 85 |
| Flex modulus | MPa | 2,810 | 2,570 |
| Flex strength | MPa | 120 | 122 |
| Notched Izod | J/m | 72.8 | 63.5 |
| Unnotched Izod | J/m | 2,130 | n.d. |
| MVR | g/10 min | 25.5 | 15.0 |

*Carried out as described herein;
“n.d.” indicates the parameter was not determined

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An article comprising a polycarbonate blend, the polycarbonate blend comprising:
a) from about 10 wt % to about 100 wt % of a first polycarbonate comprising about 10 mol % to about 100 mol % structural units derived from bisphenol acetophenone and about 0 mol % to about 90 mol % structural units derived from bisphenol A; and
b) from about 0 wt % to about 90 wt % of a second polycarbonate comprising structural units derived from bisphenol A;
wherein the yellowness index of the polycarbonate blend has an initial value of less than or equal to about 3.0 when tested on molded plaques of 3.2 mm thickness in accordance with ASTM E313;
wherein the delta yellowness index of the polycarbonate blend is less than or equal to about 6.0 after heat aging in air at about 140° C. for about 20 days when tested on molded plaques of 3.2 mm thickness in accordance with ASTM E313; and
wherein the heat deflection temperature of the polycarbonate blend is greater than or equal to about 150° C. when tested under a load of 0.45 MPa on molded plaques of 3.2 mm thickness in accordance with ISO 75.

2. The article of claim 1, wherein the article is selected from a motor vehicle headlamp lens, a motor vehicle fog lamp lens, a motor vehicle headlamp bezel, a medical device, a display device, a projector lens, a heat shield, a lighting source enclosure, and a lighting source lens.

3. The article of claim 2, wherein the display device is selected from a computer monitor screen, a laptop screen, a liquid crystal display screen, and an organic light-emitting diode screen.

4. The article of claim 2, wherein the automobile headlamp lens is selected from an outer headlamp lens and an inner headlamp lens.

5. The article of claim 4, wherein the automobile headlamp lens is an automobile outer headlamp lens.

6. The article of claim 1, wherein the article is a headlamp assembly comprising:
a) a headlamp lens comprising the polycarbonate blend;
b) a headlamp reflector, wherein the headlamp reflector comprises a polycarbonate blend composition comprising one or more polycarbonates selected from a bisphenol isophorone polycarbonate; a polycarbonate comprising structural units derived from 2-phenyl-3,3-bis(hydroxyphenyl)phthalimidine; a polycarbonate comprising structural units derived from bisphenol TMC; a polycarbonate comprising structural units derived from 9,9 bis(4-hydroxyphenyl)fluorene; and
a polycarbonate comprising structural units derived from 2,2-bis(4-hydroxyphenyl)adamantine.
c) a bezel; and
d) a housing.

7. The article of claim 6, wherein the headlamp assembly further comprises a tungsten-halogen, a halogen infrared reflective, or a high-intensity discharge light source.

8. The article of claim 7, wherein the headlamp assembly comprises a tungsten-halogen light source.

9. The article of claim 7, wherein the headlamp assembly comprises a high-intensity discharge source.

10. The article of claim 1, wherein the article comprises:
a) a headlamp lens comprising the polycarbonate blend; and
b) a headlamp reflector comprising a high heat polycarbonate composition;
wherein the high heat polycarbonate composition has a heat deflection temperature of greater than or equal to about 150° C. when tested under a load of 0.45 MPa on molded plaques of 3.2 mm thickness in accordance with ISO 75.

11. The article of claim 10, wherein the high heat polycarbonate composition comprises a bisphenol isophorone polycarbonate.

12. The article of claim 10, wherein the high heat polycarbonate composition comprises a polycarbonate comprising structural units derived from 2-phenyl-3,3-bis(hydroxyphenyl)phthalimidine.

13. The article of claim 10, wherein the high heat polycarbonate composition comprises a polycarbonate comprising structural units derived from bisphenol TMC.

14. The article of claim 10, wherein the polycarbonate composition comprises a polycarbonate composition comprising structural units derived from dihydroxyaryl fluorene.

15. The article of claim 14, wherein the dihydroxyaryl fluorene is 9,9 bis(4-hydroxyphenyl)fluorene.

16. The article of claim 10, wherein the high heat polycarbonate composition comprises structural units derived from adamantyl bisphenol.

17. The article of claim 16, wherein the adamantyl bisphenol is 2,2-bis(4-hydroxyphenyl)adamantine.

18. The article of claim 1, wherein the first polycarbonate comprises about 0 mol % structural units derived from bisphenol A and about 100 mol % structural units derived from bisphenol acetophenone.

19. The article of claim 1, wherein the first polycarbonate comprises from about 0 mol % to about 10 mol % structural units derived from bisphenol A and comprises about 90 mol % to about 100 mol % structural units derived from bisphenol acetophenone.

20. The article of claim 1, wherein the first polycarbonate is present in about 90 wt % and the second polycarbonate is present in about 10 wt %.

21. The article of claim 1, wherein the polycarbonate blend comprises a first polycarbonate present in about 100 wt %.

22. The article of claim 1, wherein the first polycarbonate has a Mw of between about 20,000 Daltons and about 30,000 Daltons.

23. The article of claim 1, wherein the first polycarbonate has a Mn of between about 10,000 and about 20,000.

24. The article of claim 1, wherein the first polycarbonate has a Mw of between about 20,000 Daltons and about 30,000 Daltons; and wherein the first polycarbonate has a Mn of between about 10,000 and about 20,000.

25. The article of claim 1, wherein the first polycarbonate has a melt flow rate (“MFR”) from about 10 g per 10 minutes to about 20 g per 10 minutes at 330° C. under a load of 2.16 kg when measured according to ISO 1133.

26. The article of claim 1, wherein the second polycarbonate has a Mw of between about 21,000 Daltons and about 31,000 Daltons.

27. The article of claim 1, wherein the second polycarbonate has a Mn of between about 10,500 and about 15,500.

28. The article of claim 1, wherein the second polycarbonate has a Mw of between about 21,000 Daltons and about 31,000 Daltons; and wherein the second polycarbonate has a Mn of between about 10,500 and about 15,500.

29. The article of claim 1, wherein the second polycarbonate has a melt flow rate (“MFR”) from about 5 g per 10 minutes to about 20 g per 10 minutes at 330° C. under a load of 2.16 kg when measured according to ISO 1133.

30. The article of claim 1, wherein the yellowness index of the polycarbonate blend has an initial value of less than or equal to about 2.0 when tested on molded plaques of 3.2 mm thickness in accordance with ASTM E313.

31. The article of claim 1, wherein the yellowness index of the polycarbonate blend has an initial value of less than or equal to about 1.0 when tested on molded plaques of 3.2 mm thickness in accordance with ASTM E313.

32. The article of claim 1, wherein the delta yellowness index of the polycarbonate blend is less than or equal to about 5.0 after heat aging in air at about 140° C. for about 20 days when tested on molded plaques of 3.2 mm thickness in accordance with ASTM E313.

33. The article of claim 1, wherein the delta yellowness index of the polycarbonate blend is less than or equal to about 3.0 after heat aging in air at about 140° C. for about 20 days when tested on molded plaques of 3.2 mm thickness in accordance with ASTM E313.

34. The article of claim 1, wherein the polycarbonate blend has less than or equal to about a 6.0% decrease in Mw after exposure to 90° C. and 100% relative humidity for seven days.

35. The article of claim 1, wherein the polycarbonate blend has a haze measurement of less than or equal to about 7.0% when measured in accordance with ASTM D-1003.

36. The article of claim 1, wherein the polycarbonate blend has a transmission measurement of greater than or equal to about 85% when measured in accordance with ASTM D-1003.

37. The article of claim 1, wherein the polycarbonate blend has a UV absorbance of less than or equal to about 0.1 when measured at 280 nm on a 10 μm thickness film.

38. The article of claim 1, wherein the heat deflection temperature is greater than or equal to about 153° C. when tested under a load of 0.45 MPa on molded plaques of 3.2 mm thickness in accordance with ISO 75.

39. The article of claim 1, wherein the heat deflection temperature is greater than or equal to about 155° C. when tested under a load of 0.45 MPa on molded plaques of 3.2 mm thickness in accordance with ISO 75.

40. The article of claim 1, wherein the heat deflection temperature is greater than or equal to about 160° C. when tested under a load of 0.45 MPa on molded plaques of 3.2 mm thickness in accordance with ISO 75.

41. The article of claim 1, wherein the polycarbonate blend further comprises at least one additive selected from thermal stabilizers, antioxidants, UV stabilizers, plasticizers, visual effect enhancers, extenders, antistatic agents, catalyst quenchers, mold releasing agents, fire retardants, blowing agents, impact modifiers and processing aids.

42. The article of claim 41, wherein the polycarbonate blend further comprises at least one additive selected from UV stabilizer, antioxidant, and mold releasing agent.

43. The article of claim 41, wherein the UV absorber is selected from 2-(2H-benzotriazol-2-yl)-4-(1,1,3,3-tetramethylbutyl)-phenol; 2-(2H-benzotriazol-2-yl)-4-(tert-butyl)-6-(sec-butyl)phenol; 2-hydroxy-4-n-octyloxybenzophenone; 2-[4,6-bis(2,4-dimethylphenyl)-1,3,5-triazin-2-yl]-5-(octyloxy)-phenol; 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; and 2-(2H-benzotriazol-2-yl)-4,6-bis(1-methyl-1-phenylethyl)phenol.

44. The article of claim 43, wherein the UV absorber is 2-(2H-benzotriazol-2-yl)-4,6-bis(1-methyl-1-phenylethyl)phenol.

45. The article of claim 41, wherein the UV absorber is present in the polycarbonate blend in an amount from about 0.0001 wt % to about 1.0 wt %.

46. The article of claim 41, wherein the anti-oxidant is selected from tris(nonyl phenyl)phosphate; tris(2,4-di-t-butylphenyl)phosphite; bis(2,4-di-t-butylphenyl)pentaerythritol diphosphite; distearyl pentaerythritol diphosphite; tetrakis[methylene(3,5-di-tert-butyl-4-hydroxyhydrocinnamate)]methane; distearylthiopropionate; dilaurylthiopropionate; ditridecylthiodipropionate; octadecyl-3-(3,5-di-tert-butyl-4-hydroxyphenyl)propionate; and pentaerythrityl-tetrakis[3-(3,5-di-tert-butyl-4-hydroxyphenyl)propionate.

47. The article of claim 46, wherein the antioxidant is tris(2,4-di-t-butylphenyl)phosphate.

48. The article of claim 46, wherein the antioxidant is tetrakis[methylene(3,5-di-tert-butyl-4-hydroxyhydrocinnamate)]methane.

49. The article of claim 41, wherein the anti-oxidant is present in the polycarbonate blend in an amount from about 0.0001 wt % to about 1.0 wt %.

50. An article comprising a polycarbonate blend, the polycarbonate blend comprising:
a polycarbonate polymer comprising from about 0 mol % to about 10 mol % structural units derived from bisphenol A and about 90 mol % to about 100 mol % structural units derived from bisphenol acetophenone;
wherein the yellowness index of the polycarbonate blend has an initial value of less than or equal to about 3.0 when tested on molded plaques of 3.2 mm thickness in accordance with ASTM E313;
wherein the delta yellowness index of the polycarbonate blend is less than or equal to about 6.0 after heat aging in air at about 140° C. for about 20 days when tested on molded plaques of 3.2 mm thickness in accordance with ASTM E313;
wherein the heat deflection temperature of the polycarbonate blend is greater than or equal to about 150° C. when tested under a load of 0.45 MPa on molded plaques of 3.2 mm thickness in accordance with ISO 75;
wherein the transmission measurement of the polycarbonate blend is greater than or equal to about 85% when measured in accordance with ASTM D-1003; and
wherein the falling dart impact strength of the polycarbonate blend is greater than or equal to about 70 J when tested in accordance with ASTM D-3029 on molded plaques of 3.2 mm thickness.

51. The article of claim 50, the polycarbonate blend further comprising a second polycarbonate comprising structural units derived from bisphenol A; wherein the polycarbonate polymer is present in an amount from about 10 wt % to about 100 wt %; and
wherein the second polycarbonate is present in an amount from about 0 wt % to about 90 wt %.

52. A headlamp lens comprising a polycarbonate blend, the polycarbonate blend comprising:
a) about 90 wt % of a first polycarbonate comprising about 90 mol % to about 100 mol % structural units derived from bisphenol acetophenone and about 0 mol % to about 10 mol % structural units derived from bisphenol A; and
b) about 10 wt % of a second polycarbonate polymer comprising structural units derived from bisphenol A;
wherein the yellowness index of the polycarbonate blend has an initial value of less than or equal to about 3.0 when tested on molded plaques of 3.2 mm thickness in accordance with ASTM E313;
wherein the delta yellowness index of the polycarbonate blend is less than or equal to about 6.0 after heat aging in air at about 140° C. for about 20 days when tested on molded plaques of 3.2 mm thickness in accordance with ASTM E313;
wherein the heat deflection temperature of the polycarbonate blend is greater than or equal to about 150° C. when tested under a load of 0.45 MPa on molded plaques of 3.2 mm thickness in accordance with ISO 75;
wherein the transmission measurement of the polycarbonate blend is greater than or equal to about 85% when measured in accordance with ASTM D-1003; and
wherein the falling dart impact strength of the polycarbonate blend is greater than or equal to about 70 J when tested on molded plaques of 3.2 mm thickness in accordance with ASTM D-3029.

53. A headlamp lens comprising a polycarbonate blend, the polycarbonate blend comprising:
a) about 90 wt % of a polycarbonate homopolymer comprising structural units derived from bisphenol acetophenone; and
b) about 10 wt % of a second polycarbonate comprising structural units derived from bisphenol A;
wherein the yellowness index of the polycarbonate blend has an initial value of less than or equal to about 3.0 when tested on molded plaques of 3.2 mm thickness in accordance with ASTM E313;
wherein the delta yellowness index of the polycarbonate blend is less than or equal to about 6.0 after heat aging in air at about 140° C. for about 20 days when tested on molded plaques of 3.2 mm thickness in accordance with ASTM E313;
wherein the heat deflection temperature of the polycarbonate blend is greater than or equal to about 150° C. when tested under a load of 0.45 MPa on molded plaques of 3.2 mm thickness in accordance with ISO 75;
wherein the transmission measurement of the polycarbonate blend is greater than or equal to about 85% when measured in accordance with ASTM D-1003; and
wherein the falling dart impact strength of the polycarbonate blend is greater than or equal to about 70 J when tested on molded plaques of 3.2 mm thickness in accordance with ASTM D-3029.

54. A headlamp lens comprising a polycarbonate blend, the polycarbonate blend comprising:
a polycarbonate homopolymer comprising structural units derived from bisphenol acetophenone;
wherein the yellowness index of the polycarbonate blend has an initial value of less than or equal to about 3.0 when tested on molded plaques of 3.2 mm thickness in accordance with ASTM E313;
wherein the delta yellowness index of the polycarbonate blend is less than or equal to about 6.0 after heat aging in air at about 140° C. for about 20 days when tested on molded plaques of 3.2 mm thickness in accordance with ASTM E313;
wherein the heat deflection temperature of the polycarbonate blend is greater than or equal to about 150° C. when tested under a load of 0.45 MPa on molded plaques of 3.2 mm thickness in accordance with ISO 75;
wherein the transmission measurement of the polycarbonate blend is greater than or equal to about 85% when measured in accordance with ASTM D-1003; and
wherein the falling dart impact strength of the polycarbonate blend is greater than or equal to about 70 J when tested on molded plaques of 3.2 mm thickness in accordance with ASTM D-3029.
